(19) United States
(12) Patent Application Publication
(10) Pub. No.: US 2015/0252122 A1
(43) Pub. Date: Sep. 10, 2015

(54) METHOD FOR MAKING AN INFUSIBLE POLYMER FROM A POLYOLEFIN

(71) Applicant: Eastman Chemical Company, Kingsport, TN (US)

(72) Inventors: Chester Wayne Sink, Kingsport, TN (US); Ernest Phillip Smith, Blountville, TN (US); Robert Thomas Hembre, Johnson City, TN (US); Jasper Clarkson, Kingsport, TN (US); Ping Peter Shang, Kingsport, TN (US)

(73) Assignee: Eastman Chemical Company, Kingsport, TN (US)

(21) Appl. No.: 14/202,474

(22) Filed: Mar. 10, 2014

(51) Int. Cl. C08F 8/36; D01F 9/32; B01J 19/24; D01F 9/21

(52) U.S. Cl. CPC C08F 8/36; D01F 9/21; D01F 9/328; B01J 19/24; B01J 2219/24; B01J 2219/00166

(57) ABSTRACT

A process for making an infusible polyolefin includes the steps of: a) contacting the polyolefin in a sulfonation reactor with a sulfonation mixture comprising sulfur trioxide to produce the infusible polyolefin; b) recovering from the sulfonation reactor a recovery stream having sulfur dioxide; c) oxidizing at least a portion of the recovered sulfur dioxide to produce a recycle stream; and d) combining at least a portion of the recycle stream with the sulfonation mixture of step (a).

Another aspect of the invention is for making a carbonized fiber from an infusible polyolefin of the present invention and further includes the step of carbonizing the infusible polyolefin to produce a carbon fiber.

Another aspect of the invention is an apparatus for preparing an infusible polyolefin. The apparatus includes a plurality of compartments in fluid communication wherein at least one compartment is adapted for contacting a polyolefin with sulfur trioxide.

### BACKGROUND OF THE INVENTION

1. Field of the Invention

The present invention relates to a process to make an infusible polyolefin, that is, a polyolefin suitable for making a carbon fiber by being carbonized at elevated temperatures utilizing known carbonation processes and apparatus without decomposing and melting. Advantageously, the process of the present invention minimizes the release of polluting wastes, such as, carbon dioxide, sulfur dioxide and nitrous oxides and further advantageously reduces the quantity of dilute acid streams, such as sulfuric acid.

2. Background

Carbon and graphite fibers are increasingly used in the manufacture of components for lightweight aircraft, aerospace structures, automobile parts, and sporting equipment. Carbon fiber generally refers to a bundle of 1000 to 48,000 filaments of 6-12 micron each, where each filament is composed of >96% carbon in a predominately graphene structure. Carbon fiber possesses both tensile strength and stiffness at a low density to provide composites with thermoset or thermoplastic resins with structural properties similar to heavier materials such as high strength steel, and aluminum.

There are several known methods of producing carbon shaped articles, such as carbon fibers. Representative methods include using pitch as a raw material. Carbonaceous material is typically melted, spun into thread or filament form, and converted to a carbon or graphite fiber. The spun filament or filaments are stabilized, i.e. rendered infusible, through a heat treatment in an oxidizing atmosphere, and thereafter heated to a higher temperature in an inert atmosphere to convert the infusible filament into a carbon or graphite fiber. A large percentage of commercial carbon fiber processes employ mesophase pitch as the carbon source or graphite fiber. The pitch is formed into a fibrous shape by melt spinning. The fibers are then subjected to infusibilization treatment and then carbonized using known heat treatments. For example, a characteristic feature of producing the carbon fibers from pitch is that natural or synthetic organic compounds are baked at a temperature of from 300° to 500° C. in an inert gas atmosphere to obtain a pitch substance in a molten state. The molten pitch substance is then subjected to melt spinning to form a fiber or strand. The spun filaments are then oxidized to infusibilize so the individual filament may not be fused together by further heat-treatment. The infusibilize filaments are then subjected to carbonization, followed by, if necessary, a graphitization treatment, thereby obtaining the carbonaceous or graphitic fibers. In such an example, the melt spinning is carried out by using the raw material pitch of a particular class having a mean molecular weight of 400 or above. The high cost of the graphite fibers produced is due primarily to the cost of producing the mesophase pitch as the base of such fiber manufacture. Further, most of the commercial fibers produced from mesophase pitch have been fibers that have been subsequently converted to graphite fibers.

In another process, the fibers derived from natural or synthetic high polymer materials such as polyacrylonitrile, polybenzimidasole, and cellulose are baked. Carbon fiber bodies are typically formed from carbon fiber body precursors, such as, for example, preoxidized polyacrylonitrile (PAN) which is commonly used as a carbon fiber body precursor. Carbon fiber body precursors may be manipulated and fabricated in a manner similar to a textile (e.g., weaving, knitting, etc) to form desired structures. To transform the carbon fiber body precursor into a carbon fiber body, various methods and techniques may be used. For example, during transformation of PAN materials, the PAN fiber may be carbonized and then processed to eliminate metals or other impurities that may be found in the PAN fiber.

Transformation of carbon fiber body precursors, such as PAN fibers and preformed articles, often occurs in a two-stage process. The first stage may be a carbonization stage. A carbonization stage is typically performed at temperatures of less than 1100° C., and most typically between about 800° C. and 950° C. The second stage may be a high temperature stage, typically using temperatures over 1400° C. A large portion of the PAN fiber is removed as cyanide in this process which must be treated before disposal, typically with an energy intensive thermal oxidation.

In another process carbon fibers have been prepared from polyethylene fiber by liquid immersion sulfonation of the polyethylene fiber (e.g., by treatment with chlorosulfonic or sulfuric acid), followed by pyrolysis. The sulfonation step makes the polyethylene fiber thermally infusible, and thus, carbonizable at the high temperatures employed for carbonization. However, the liquid immersion sulfonation process, as conventionally practiced, has a drawback of being either very slow with respect to the degree of sulfonation provided to the polyethylene fiber, or very aggressive such that the reaction is uncontrollable before it achieves equilibrium or complete sulfonation (i.e., a saturated level of sulfonation) of the precursor fiber. Although not to be bound by any theory, it is believed that physical and chemical changes that occur on the polymer surface during the reactions just described, leads to dehydrogenation with the formation of olefinic bonds.

Another problem associated with preparing an infusible polymer using a polyolefin is evolution of sulfur dioxide and carbon dioxide during the reaction between concentrated sulfuric acid with polyolefins, oleum with polyolefins or sulfur trioxide with polyolefins.

Accordingly, there is a need for a process for preparing an infusible polyolefin using a sulfoxide that addresses the problems described above.

### SUMMARY OF THE INVENTION

Advantageously, the inventors have discovered a process for making polyolefins infusible, i.e., able to be carbonized without decomposing and melting, that proceeds quicker and at lower temperatures than other methods and avoids the release of large quantities of polluting wastes or producing large quantities of dilute acid streams, by integrating a reduction oxidation process for the indirect oxidation and cross-linking of the polyolefin. We have surprisingly discovered using sulfur trioxide will produce an infusible fiber at a lower temperature than previously disclosed. Additionally, we have discovered a method to recycle the consumed reagent by oxidation (SO₂+½O₂→SO₃) to provide an integrated reduction oxidation process. The sulfur trioxide may be gaseous or dissolved in liquid state that is dissolved in suitable carrier such as sulfuric acid as oleum, to react with the polyolefin to make it infusible.

We have further discovered that unsaturated polyolefins will react faster still and require less sulfur trioxide than polyethylene, and can allow a smaller reagent recycle process and lower consumption of oxygen.

Briefly, the present invention is a process for making an infusible polyolefin including the steps of: a) contacting the polyolefin in a sulfonation reactor with a sulfonation mixture comprising sulfur trioxide to produce the infusible polyolefin; b) recovering from the sulfonation reactor a recovery stream having sulfur dioxide; c) oxidizing at least a portion of the recovered sulfur dioxide in the recovery stream to produce an enriched recycle stream having an increased concentration of sulfur trioxide relative to the recovery stream; and d) combining at least a portion of the recycle stream with the sulfonation mixture of step (a).

Advantageously, the process of the present invention minimizes the release of polluting wastes, such as, carbon dioxide, sulfur dioxide and nitrous oxides and further advantageously reduces the quantity of dilute acid streams, such as sulfuric acid.

Another aspect of the present invention is a process for making an infusible polyolefin as described above wherein the polyolefin includes at least one unsaturated carbon to carbon bond positioned and beginning on a carbon atom that is positioned adjacent to a terminal carbon atom up to 50% away from a terminal carbon atom on the copolymer backbone, or at least 20% away and up to 50% away, or at least 25% away up to 50% away, from a terminal carbon on the copolymer backbone.

Another aspect of the present invention is a process for making a carbon fiber having the steps of a) contacting a polyolefin with a sulfonation mixture comprising sulfur trioxide in a sulfonation reactor to produce an infusible polyolefin; b) recovering from the sulfonation reactor a first recovery stream comprising sulfur dioxide; c) oxidizing at least a portion of the sulfur dioxide in the recovery stream to produce a recycle stream wherein the recycle stream has an increased concentration of sulfur trioxide relative to the first recovery stream; d) combining at least a portion of the recycle stream with the sulfonation mixture of step (a); and e) heating the infusible polyolefin to produce a carbon fiber.

Another aspect of the present invention is for an apparatus for making an infusible fiber, wherein the apparatus includes a plurality of compartments wherein at least one compartment is adapted for contacting a polyolefin with a gaseous sulfoxide.

These and other objects and advantages of the present invention will become more apparent to those skilled in the art in view of the following description and the accompanying drawings wherein like parts and objects in the several views have similar reference numerals. It is to be understood that the inventive concept is not to be considered limited to the constructions disclosed herein but instead by the scope of the appended claims.

### BRIEF DESCRIPTION OF THE FIGURES

FIG. 1 is a box diagram of the present invention of making an infusible polymer from a polyolefin wherein sulfur dioxide is recovered and a portion of the sulfur dioxide is oxidized to sulfur trioxide and at least a portion of the sulfur trioxide is recycled to a polymer oxidation reactor.

FIG. 2 is a box diagram of another embodiment of the present invention wherein in addition to recovering sulfur dioxide from making an infusible polymer, sulfur dioxide is additionally recovered from a process for making a carbon fiber from the infusible polymer.

FIG. 3 is a plan view of an apparatus for preparing an infusible polyolefin in accordance with the present invention.

### DETAILED DESCRIPTION OF THE INVENTION

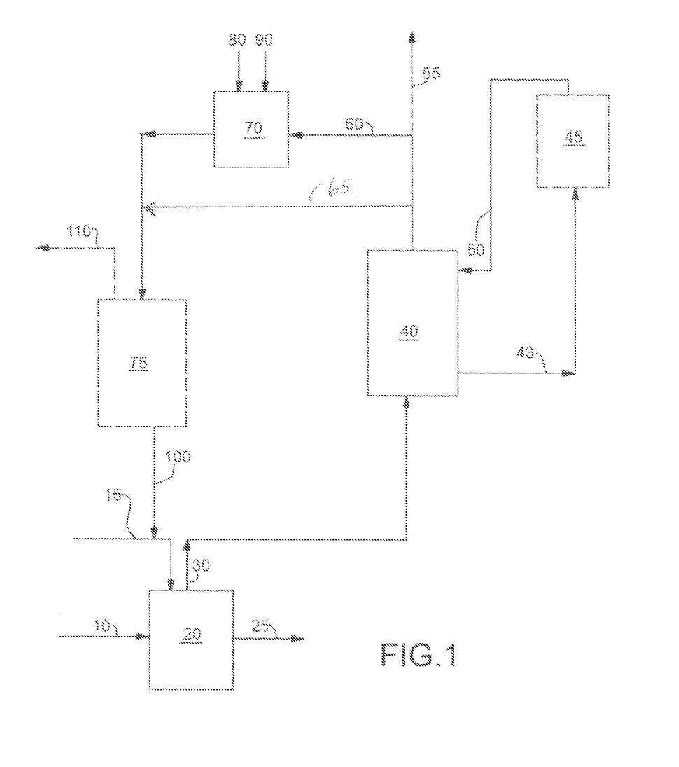

Referring to FIG. 1, in accordance with one aspect of the present invention, a process for making an infusible polyolefin is shown. The process includes the steps of: (a) contacting a polyolefin 10 in a sulfonation reactor 20 with a sulfonation mixture 15 having sulfur trioxide to produce an infusible polyolefin 25; (b) recovering from the sulfonation reactor 20 a recovery stream 30 having sulfur dioxide; (c) oxidizing at least a portion of the sulfur dioxide in the recovery stream 30 in an oxidizer 70 to produce a recycle stream 100 so that the recycle stream 100 has an increased concentration of sulfur trioxide, relative to the recovery stream 30; and (d) combining at least a portion of the recycle 100 stream with the sulfonation mixture 15 of step (a).

In the first step (a) the polyolefin 10 is contacted with a sulfonation mixture 15 that includes sulfur trioxide. The polyolefin 10 is introduced into the sulfonation reactor 20 and is contacted with a sulfonation mixture 15 to produce the infusible polyolefin 25. As used herein the term “infusible” generally means that the polymers obtained according to the invention may be carbonized without decomposing or melting. Accordingly, the amount of infusibility desired is a function of the ease with which the polymer may thereafter be carbonized without an undue loss of material infusible is thus a functional term that is not intended to be particularly limiting.

The polyolefin 10 can be any polyolefin. The polyolefin is typically thermoplastic and/or elastomeric, but may also be a thermoset if sufficiently cross-linked. As used herein, the term “polyolefin” refers to any polymer produced by addition polymerization and includes both saturated polyolefins and unsaturated polyolefins, and both aromatic and aliphatic polyolefins. The unsaturated hydrocarbon considered herein is generally composed exclusively of carbon and hydrogen. In some embodiments, one or more hydrogen atoms of the hydrocarbon may be replaced with a heteroatom-containing group, such as one or more halogen atoms, hydroxyl groups, amino groups, ether groups, thiol groups, thioether groups, or aldehyde groups. The heteroatom-containing group may also interrupt a carbon-carbon bond, as in the case of carbonyl (CO), oxygen (—O—), sulfur (—S—), or any of the above exemplary groups, where applicable (e.g., an amino group linking two or three carbon atoms).

In some aspects, the polyolefin may comprise a saturated aliphatic polyolefin, or unsaturated aliphatic polyolefin, or alkyl polyolefin, or aromatic polyolefin, or mixed polyolefins made from mixtures of the foregoing or copolymers from their constituent monomers. Some examples of unsaturated hydrocarbons useful for producing respective addition polymers include ethylene, propylene, 2-butene, isoprene, butadiene, styrene, and copolymers thereof. In other embodiments the polyolefin is a copolymer of at least two monomers wherein one monomer is selected from ethylene or propylene, and a second monomer is selected from 2-butene, isoprene, butadiene, styrene, or combinations thereof.

In the case wherein the polyolefin includes at least one unsaturated carbon to carbon bond, desirably the unsaturation begins on a carbon atom that is positioned adjacent to a terminal carbon atom up to 50% away from a terminal carbon atom. In other embodiments, the polyolefin includes at least one unsaturated carbon to carbon bond at least 15% away from a terminal carbon atom and up to 50% away from a terminal carbon atom on the copolymer backbone, or at least 20% away from a terminal carbon atom and up to 50% away from a terminal carbon atom, or at least 25% away from a terminal carbon atom up to 50% away from a terminal carbon on the copolymer backbone.

In other embodiments, the degree of unsaturation in the polyolefin backbone can be from about 1% to about 50% prior to sulfonation, or from about 2% to about 45%, or from about 3% to about 40%, or from about 4% to about 35%, or from about 5% to about 30%, or from about 6% to about 25%, or from about 7% to about 20%, or from about 8% to about 15%, or from about 1% to about 10% prior to sulfonation of the polyolefin.

In some embodiments the polyolefin comprises from about 1 mole % to about 10 mole % butadiene and from about 99 mole % to about 90 mole % ethylene, from about 2 mole % to about 9 mole % butadiene and from about 98 mole % to about 91 mole % ethylene, from about 3 mole % to about 7 mole % butadiene and from about 97 mole % to about 93 mole % ethylene, from about 4 mole % to about 6 mole % butadiene and from about 96 mole % to about 94 mole % ethylene, from about 5 mole % to about 10 mole % butadiene and from about 95 mole % to about 90 mole % ethylene.

In one embodiment, the polyolefin can be any polyolefin having a unitary chain length of from about 2 to about 24 carbon atoms; in another embodiment from about 2 to about 23 carbon atoms; in another embodiment from about 2 to about 22 carbon atoms; in another embodiment from about 2 to about 21 carbon atoms; in another embodiment from about 2 to about 20 carbon atoms; in another embodiment from about 2 to about 19 carbon atoms; in another embodiment from about 2 to about 18 carbon atoms; in another embodiment from about 2 to about 17 carbon atoms; in another embodiment from about 2 to about 16 carbon atoms; in another embodiment from about 2 to about 15 carbon atoms; in another embodiment from about 2 to about 14 carbon atoms; in another embodiment from about 2 to about 13 carbon atoms; in another embodiment from about 2 to about 12 carbon atoms; in another embodiment from about 2 to about 11 carbon atoms; in another embodiment from about 2 to about 10 carbon atoms; in another embodiment from about 2 to about 9 carbon atoms; in another embodiment from about 2 to about 8 carbon atoms; in another embodiment from about 2 to about 7 carbon atoms; in another embodiment from about 2 to about 6 carbon atoms; in another embodiment from about 2 to about 5 carbon atoms; in another embodiment from about 2 to about 4 carbon atoms; in another embodiment from about 2 to about 3 carbon atoms and copolymers of any of the aforementioned polyolefins. In another embodiment, the polyolefin is selected from polyethylene, polypropylene, polybutylene and homogeneous or heterogeneous copolymers thereof.

In the case of polyethylene, the polyethylene can be any of the types of polyethylene known in the art, such as for example, low density polyethylene (LDPE), linear low density polyethylene (LLDPE), very low density polyethylene (VLDPE), high density polyethylene (HDPE), medium density polyethylene (MDPE), high molecular weight polyethylene (HMWPE), and ultra high molecular weight polyethylene (UHMWPE).

In the case of polypropylene, the polypropylene can also be any of the types of polypropylenes known in the art, such as, isotactic, atactic, and syndiotactic polypropylene. The polyolefin precursor may or may not also be derived from, or include segments or monomeric units of other addition monomers, such as acrylic acid, methacrylic acid, methyl acrylate, methyl methacrylate, vinyl acetate (as well as partially or fully hydrolyzed derivatives of vinyl acetate, such as vinyl alcohol), and acrylonitrile, except that the polyolefin precursor preferably does not include these other addition monomers in more than an equal amount by monomer number or weight.

The polyolefin can be a fiber having any desired thickness (i.e., diameter). For example, in different embodiments, the fiber can have a thickness of 0.1, 0.2, 0.5, 1, 2, 5, 10, 15, 20, 30, 40, 50, 60, 70, 80, 90, or 100 microns, or a thickness within a range bounded by any two of these values. In some embodiments, the fiber is in the form of a tow, while in other embodiments the fiber is in the form of a single filament. Continuous filaments or tows from very low count (<500) to very high counts (>50,000) are considered herein. Such fibers may also be stapled or chopped (short-segment). The polyolefin fiber may also be in the form of a fiber, yarn, fabric, mesh, or felt.

The polyolefin fiber can be produced by any of the methods known in the art. In some embodiments, the polyolefin fiber is produced using a melt-spinning process. In other embodiments, the fiber is produced using a solution-spinning process (fiber is produced by coagulation of solid fiber from solution of the polymer in a solvent). The conditions and methodology employed in melt-spinning and solution-spinning processes are well known in the art. Moreover, the fiber precursor may be produced utilizing a single or bi-component extrusion process. The conditions and methodology employed in single or bi-component extrusion processes are also well known in the art.

In the sulfonation process, the polyolefin 10 is at least partially sulfonated by contacting the polyolefin 10 with a sulfonation mixture 15 using any of the methods and conditions known in the art for sulfonating a polyolefin. Generally, the sulfonation methods and conditions considered herein include where the polymer is exposed to a source of SOₓ species, such as for example SO₃ in an inert environment for the purpose of sulfonating the polyolefin. The sulfonation methods and conditions considered herein can be, for example, any of the processes known in the art in which a polymer is sulfonated using either a liquid or gaseous phase, for example, using sulfuric acid, fuming sulfuric acid (oleum), or chlorosulfonic acid, or their mixtures, in order to sulfonate the polymer fiber. The polyolefin is contacted with the sulfonation mixture in a sulfonation reactor 20 under conditions suitable for producing an infusible fiber. The period of time (i.e., residence time) that the polyolefin fiber is exposed to the sulfonating species as well as the temperature during exposure to the sulfonating species (i.e., sulfonation temperature) can be suitably adjusted to ensure the predetermined level of sulfonation.

The sulfonation temperature is generally below a carbonization temperature. Typically, sulfonation temperature is from about 10° C., 20° C., 30° C., 40° C., 50° C., 60° C., 70° C., 80° C., 90° C., 100° C., 110° C., 120° C., 130° C., 140° C., 150° C., 160° C., 170° C., 180° C., 190° C., 200° C., 210° C., 220° C., 230° C., 240° C., 250° C., 260° C., 270° C., 280° C., 290° C., or 300° C., or a sulfonation temperature within a range bounded by any two of the foregoing values (for example, at least or above 10° C., 20° C., 40° C., 50° C., and up to or less than 120° C., 130° C., 140° C., 150° C., 160° C., 170° C., 180° C., 190° C., 200° C., 250° C., or 300° C., or at least or above 20° C., and up to or less than 120° C., 1440° C., 160° C., 170° C., 180° C., or 200° C., or at least or above 20° C., and up to or less than 80° C., 90° C., 100° C., 120° C., 140° C., 160° C., or 180° C.). In another embodiment, the temperature of the sulfonation mixture is from about 10° C. to about 120° C., from about 10° C. to about 95° C., from about 20° C. to about 80° C. or from about 40° C. to about 80° C., including all temperatures within a range bounded by any two of the foregoing values.

The residence time at sulfonation is very much dependent on several variables, including the sulfonation temperature used, concentration of sulfonating agent in the reaction medium, level of applied tension (if any), crystallinity of the polyolefin polymer, and the thickness of the polyolefin fiber. The residence time is also dependent on the sulfonation method used (i.e., liquid phase, gas phase or a combination utilizing both phase processes). As would be appreciated by one skilled in the art, the degree of sulfonation achieved at a particular sulfonating temperature and residence time can be replicated by use of a higher sulfonation temperature at a shorter residence time, or by use of a lower sulfonation temperature at a longer residence time. Similarly, the residence time required to achieve a degree of sulfonation in a polyolefin fiber of a certain thickness may result in a higher degree of sulfonation in a thinner fiber and a lower degree of sulfonation in a thicker fiber with all other conditions and variables normalized. However, generally, for polyolefin fibers having a thickness in the range of 0.5 to 50 microns, the residence time at sulfonation is typically no more than 90 minutes to ensure at least partial sulfonation (i.e., where sulfonation has not occurred through the entire diameter of the fiber through the core, thus producing a surface-sulfonated polyolefin fiber). In different embodiments, depending on such variables as the sulfonation temperature and fiber thickness, the residence time at sulfonation may be up to, or less than 90 minutes, 80 minutes, 70 minutes, 60 minutes (1 hour), 50 minutes, 40 minutes, 30 minutes, 20 minutes, 10 minutes, 5 minutes, 3 minutes, 2 minutes, or 1 minute, or a residence time within a range bounded by any two of the foregoing values. In another embodiment residence time at sulfonation is of from about 0.5 seconds to about 2 hours, or from about 1 second to about 1 hour, or from about 5 seconds to about 30 minutes, or a residence time within a range bounded by any two of the foregoing values and under conditions of an inert atmosphere or an oxidizing environment.

In the case were the polyolefin is in the form of a fiber or continuous thread, in some embodiments the sulfonation process is practiced without applying a stress (tension) along the length of the fiber or thread. In other embodiments, the sulfonation process, is practiced by applying a stress along the fiber or thread length. For example, the stress can be applied to avoid fiber shrinkage. In particular embodiments, a high degree of axial stress (e.g., 10 MPa or higher) is applied when a small pore size and narrow pore size distribution is desired. In some embodiments, 0, 0.1, 0.3, 0.5, 1, 2, 5, 10, or 20 MPa of stress is applied in each step involving sulfonation and/or carbonization to obtain a desired morphology in the carbonized fiber.

In varying embodiments, the sulfonation mixture includes sulfur trioxide ranging from about 0.01 to about 100 mole percent, based on the total moles of sulfur containing compounds in the sulfonation mixture. In other embodiments the sulfonation mixture includes: from about 0.1 to about 100 mole percent, from about 1.0 to about 100 mole percent, from about 2.0 to about 100 mole percent, from about 3.0 to about 100 mole percent, from about 4.0 to about 100 mole percent, from about 5.0 to about 100 mole percent, from about 6.0 to about 100 mole percent, from about 7.0 to about 100 mole percent, from about 8.0 to about 100 mole percent, from about 9.0 to about 100 mole percent, from about 10.0 to about 100 mole percent, from about 11.0 to about 100 mole percent, from about 12.0 to about 100 mole percent, from about 13.0 to about 100 mole percent, from about 14.0 to about 100 mole percent, from about 15.0 to about 100 mole percent, from about 16.0 to about 100 mole percent, from about 17.0 to about 100 mole percent, from about 18.0 to about 100 mole percent, from about 19.0 to about 100 mole percent, from about 20.0 to about 100 mole percent, from about 21.0 to about 100 mole percent, from about 22.0 to about 100 mole percent, from about 23.0 to about 100 mole percent, from about 24.0 to about 100 mole percent, from about 25.0 to about 100 mole percent, from about 26.0 to about 100 mole percent, from about 27.0 to about 100 mole percent, from about 28.0 to about 100 mole percent, from about 29.0 to about 100 mole percent, from about 30.0 to about 100 mole percent, from about 31.0 to about 100 mole percent, from about 32.0 to about 100 mole percent, from about 32.0 to about 100 mole percent, from about 33.0 to about 100 mole percent, from about 34.0 to about 100 mole percent, from about 35.0 to about 100 mole percent, from about 36.0 to about 100 mole percent, from about 37.0 to about 100 mole percent, from about 38.0 to about 100 mole percent, from about 39.0 to about 100 mole percent, from about 40.0 to about 100 mole percent, about 0.01 to about 99 mole percent, based on the total moles of sulfur containing compounds, from about 0.1 to about 99 mole percent, from about 1.0 to about 99 mole percent, from about 2.0 to about 99 mole percent, from about 3.0 to about 99 mole percent, from about 4.0 to about 99 mole percent, from about 5.0 to about 99 mole percent, from about 6.0 to about 99 mole percent, from about 7.0 to about 99 mole percent, from about 8.0 to about 99 mole percent, from about 9.0 to about 99 mole percent, from about 10.0 to about 99 mole percent, from about 11.0 to about 99 mole percent, from about 12.0 to about 99 mole percent, from about 13.0 to about 99 mole percent, from about 14.0 to about 99 mole percent, from about 15.0 to about 99 mole percent, from about 16.0 to about 99 mole percent, from about 17.0 to about 99 mole percent, from about 18.0 to about 99 mole percent, from about 19.0 to about 99 mole percent, from about 20.0 to about 99 mole percent, from about 21.0 to about 99 mole percent, from about 22.0 to about 99 mole percent, from about 23.0 to about 99 mole percent, from about 24.0 to about 99 mole percent, from about 25.0 to about 99 mole percent, from about 26.0 to about 99 mole percent, from about 27.0 to about 99 mole percent, from about 28.0 to about 99 mole percent, from about 29.0 to about 99 mole percent, from about 30.0 to about 99 mole percent, from about 31.0 to about 99 mole percent, from about 32.0 to about 99 mole percent, from about 32.0 to about 99 mole percent, from about 33.0 to about 99 mole percent, from about 34.0 to about 99 mole percent, from about 35.0 to about 99 mole percent, from about 36.0 to about 99 mole percent, from about 37.0 to about 99 mole percent, from about 38.0 to about 99 mole percent, from about 39.0 to about 99 mole percent, from about 40.0 to about 99 mole percent, about 0.01 to about 98 mole percent, based on the total moles of sulfur containing compounds, from about 0.1 to about 98 mole percent, from about 1.0 to about 98 mole percent, from about 2.0 to about 98 mole percent, from about 3.0 to about 98 mole percent, from about 4.0 to about 98 mole percent, from about 5.0 to about 98 mole percent, from about 6.0 to about 98 mole percent, from about 7.0 to about 98 mole percent, from about 8.0 to about 98 mole percent, from about 9.0 to about 98 mole percent, from about 10.0 to about 98 mole percent, from about 11.0 to about 98 mole percent, from about 12.0 to about 98 mole percent, from about 13.0 to about 98 mole percent, from about 14.0 to about 98 mole percent, from about 15.0 to about 98 mole percent, from about 16.0 to about 98 mole percent, from about 17.0 to about 98 mole percent, from about 18.0 to about 98 mole percent, from about 19.0 to about 98 mole percent, from about 20.0 to about 98 mole percent, from about 21.0 to about 98 mole percent, from about 22.0 to about 98 mole percent, from about 23.0 to about 98 mole percent, from about 24.0 to about 98 mole percent, from about 25.0 to about 98 mole percent, from about 26.0 to about 98 mole percent, from about 27.0 to about 98 mole percent, from about 28.0 to about 98 mole percent, from about 29.0 to about 98 mole percent, from about 30.0 to about 98 mole percent, from about 31.0 to about 98 mole percent, from about 32.0 to about 98 mole percent, from about 32.0 to about 98 mole percent, from about 33.0 to about 98 mole percent, from about 34.0 to about 98 mole percent, from about 35.0 to about 98 mole percent, from about 36.0 to about 98 mole percent, from about 37.0 to about 98 mole percent, from about 38.0 to about 98 mole percent, from about 39.0 to about 98 mole percent, from about 40.0 to about 98 mole percent, about 0.01 to about 97 mole percent, based on the total moles of sulfur containing compounds, from about 0.1 to about 97 mole percent, from about 1.0 to about 97 mole percent, from about 2.0 to about 97 mole percent, from about 3.0 to about 97 mole percent, from about 4.0 to about 97 mole percent, from about 5.0 to about 97 mole percent, from about 6.0 to about 97 mole percent, from about 7.0 to about 97 mole percent, from about 8.0 to about 97 mole percent, from about 9.0 to about 97 mole percent, from about 10.0 to about 97 mole percent, from about 11.0 to about 97 mole percent, from about 12.0 to about 97 mole percent, from about 13.0 to about 97 mole percent, from about 14.0 to about 97 mole percent, from about 15.0 to about 97 mole percent, from about 16.0 to about 97 mole percent, from about 17.0 to about 97 mole percent, from about 18.0 to about 97 mole percent, from about 19.0 to about 97 mole percent, from about 20.0 to about 97 mole percent, from about 21.0 to about 97 mole percent, from about 22.0 to about 97 mole percent, from about 23.0 to about 97 mole percent, from about 24.0 to about 97 mole percent, from about 25.0 to about 97 mole percent, from about 26.0 to about 97 mole percent, from about 27.0 to about 97 mole percent, from about 28.0 to about 97 mole percent, from about 29.0 to about 97 mole percent, from about 30.0 to about 97 mole percent, from about 31.0 to about 97 mole percent, from about 32.0 to about 97 mole percent, from about 32.0 to about 97 mole percent, from about 33.0 to about 97 mole percent, from about 34.0 to about 97 mole percent, from about 35.0 to about 97 mole percent, from about 36.0 to about 97 mole percent, from about 37.0 to about 97 mole percent, from about 38.0 to about 97 mole percent, from about 39.0 to about 97 mole percent, from about 40.0 to about 97 mole percent, about 0.01 to about 96 mole percent, based on the total moles of sulfur containing compounds, from about 0.1 to about 96 mole percent, from about 1.0 to about 96 mole percent, from about 2.0 to about 96 mole percent, from about 3.0 to about 96 mole percent, from about 4.0 to about 96 mole percent, from about 5.0 to about 96 mole percent, from about 6.0 to about 96 mole percent, from about 7.0 to about 96 mole percent, from about 8.0 to about 96 mole percent, from about 9.0 to about 96 mole percent, from about 10.0 to about 96 mole percent, from about 11.0 to about 96 mole percent, from about 12.0 to about 96 mole percent, from about 13.0 to about 96 mole percent, from about 14.0 to about 96 mole percent, from about 15.0 to about 96 mole percent, from about 16.0 to about 96 mole percent, from about 17.0 to about 96 mole percent, from about 18.0 to about 96 mole percent, from about 19.0 to about 96 mole percent, from about 20.0 to about 96 mole percent, from about 21.0 to about 96 mole percent, from about 22.0 to about 96 mole percent, from about 23.0 to about 96 mole percent, from about 24.0 to about 96 mole percent, from about 25.0 to about 96 mole percent, from about 26.0 to about 96 mole percent, from about 27.0 to about 96 mole percent, from about 28.0 to about 96 mole percent, from about 29.0 to about 96 mole percent, from about 30.0 to about 96 mole percent, from about 31.0 to about 96 mole percent, from about 32.0 to about 96 mole percent, from about 32.0 to about 96 mole percent, from about 33.0 to about 96 mole percent, from about 34.0 to about 96 mole percent, from about 35.0 to about 96 mole percent, from about 36.0 to about 96 mole percent, from about 37.0 to about 96 mole percent, from about 38.0 to about 96 mole percent, from about 39.0 to about 96 mole percent, from about 40.0 to about 96 mole percent, about 0.01 to about 95 mole percent, based on the total moles of sulfur containing compounds, from about 0.1 to about 95 mole percent, from about 1.0 to about 95 mole percent, from about 2.0 to about 95 mole percent, from about 3.0 to about 95 mole percent, from about 4.0 to about 95 mole percent, from about 5.0 to about 95 mole percent, from about 6.0 to about 95 mole percent, from about 7.0 to about 95 mole percent, from about 8.0 to about 95 mole percent, from about 9.0 to about 95 mole percent, from about 10.0 to about 95 mole percent, from about 11.0 to about 95 mole percent, from about 12.0 to about 95 mole percent, from about 13.0 to about 95 mole percent, from about 14.0 to about 95 mole percent, from about 15.0 to about 95 mole percent, from about 16.0 to about 95 mole percent, from about 17.0 to about 95 mole percent, from about 18.0 to about 95 mole percent, from about 19.0 to about 95 mole percent, from about 20.0 to about 95 mole percent, from about 21.0 to about 95 mole percent, from about 22.0 to about 95 mole percent, from about 23.0 to about 95 mole percent, from about 24.0 to about 95 mole percent, from about 25.0 to about 95 mole percent, from about 26.0 to about 95 mole percent, from about 27.0 to about 95 mole percent, from about 28.0 to about 95 mole percent, from about 29.0 to about 95 mole percent, from about 30.0 to about 95 mole percent, from about 31.0 to about 95 mole percent, from about 32.0 to about 95 mole percent, from about 32.0 to about 95 mole percent, from about 33.0 to about 95 mole percent, from about 34.0 to about 95 mole percent, from about 35.0 to about 95 mole percent, from about 36.0 to about 95 mole percent, from about 37.0 to about 95 mole percent, from about 38.0 to about 95 mole percent, from about 39.0 to about 95 mole percent, from about 40.0 to about 95 mole percent, about 0.01 to about 94 mole percent, based on the total moles of sulfur containing compounds, from about 0.1 to about 94 mole percent, from about 1.0 to about 94 mole percent, from about 2.0 to about 94 mole percent, from about 3.0 to about 94 mole percent, from about 4.0 to about 94 mole percent, from about 5.0 to about 94 mole percent, from about 6.0 to about 94 mole percent, from about 7.0 to about 94 mole percent, from about 8.0 to about 94 mole percent, from about 9.0 to about 94 mole percent, from about 10.0 to about 94 mole percent, from about 11.0 to about 94 mole percent, from about 12.0 to about 94 mole percent, from about 13.0 to about 94 mole percent, from about 14.0 to about 94 mole percent, from about 15.0 to about 94 mole percent, from about 16.0 to about 94 mole percent, from about 17.0 to about 94 mole percent, from about 18.0 to about 94 mole percent, from about 19.0 to about 94 mole percent, from about 20.0 to about 94 mole percent, from about 21.0 to about 94 mole percent, from about 22.0 to about 94 mole percent, from about 23.0 to about 94 mole percent, from about 24.0 to about 94 mole percent, from about 25.0 to about 94 mole percent, from about 26.0 to about 94 mole percent, from about 27.0 to about 94 mole percent, from about 28.0 to about 94 mole percent, from about 29.0 to about 94 mole percent, from about 30.0 to about 94 mole percent, from about 31.0 to about 94 mole percent, from about 32.0 to about 94 mole percent, from about 32.0 to about 94 mole percent, from about 33.0 to about 94 mole percent, from about 34.0 to about 94 mole percent, from about 35.0 to about 94 mole percent, from about 36.0 to about 94 mole percent, from about 37.0 to about 94 mole percent, from about 38.0 to about 94 mole percent, from about 39.0 to about 94 mole percent, from about 40.0 to about 94 mole percent, about 0.01 to about 93 mole percent, based on the total moles of sulfur containing compounds, from about 0.1 to about 93 mole percent, from about 1.0 to about 93 mole percent, from about 2.0 to about 93 mole percent, from about 3.0 to about 93 mole percent, from about 4.0 to about 93 mole percent, from about 5.0 to about 93 mole percent, from about 6.0 to about 93 mole percent, from about 7.0 to about 93 mole percent, from about 8.0 to about 93 mole percent, from about 9.0 to about 93 mole percent, from about 10.0 to about 93 mole percent, from about 11.0 to about 93 mole percent, from about 12.0 to about 93 mole percent, from about 13.0 to about 93 mole percent, from about 14.0 to about 93 mole percent, from about 15.0 to about 93 mole percent, from about 16.0 to about 93 mole percent, from about 17.0 to about 93 mole percent, from about 18.0 to about 93 mole percent, from about 19.0 to about 93 mole percent, from about 20.0 to about 93 mole percent, from about 21.0 to about 93 mole percent, from about 22.0 to about 93 mole percent, from about 23.0 to about 93 mole percent, from about 24.0 to about 93 mole percent, from about 25.0 to about 93 mole percent, from about 26.0 to about 93 mole percent, from about 27.0 to about 93 mole percent, from about 28.0 to about 93 mole percent, from about 29.0 to about 93 mole percent, from about 30.0 to about 93 mole percent, from about 31.0 to about 93 mole percent, from about 32.0 to about 93 mole percent, from about 32.0 to about 93 mole percent, from about 33.0 to about 93 mole percent, from about 34.0 to about 93 mole percent, from about 35.0 to about 93 mole percent, from about 36.0 to about 93 mole percent, from about 37.0 to about 93 mole percent, from about 38.0 to about 93 mole percent, from about 39.0 to about 93 mole percent, from about 40.0 to about 93 mole percent, about 0.01 to about 92 mole percent, based on the total moles of sulfur containing compounds, from about 0.1 to about 92 mole percent, from about 1.0 to about 92 mole percent, from about 2.0 to about 92 mole percent, from about 3.0 to about 92 mole percent, from about 4.0 to about 92 mole percent, from about 5.0 to about 92 mole percent, from about 6.0 to about 92 mole percent, from about 7.0 to about 92 mole percent, from about 8.0 to about 92 mole percent, from about 9.0 to about 92 mole percent, from about 10.0 to about 92 mole percent, from about 11.0 to about 92 mole percent, from about 12.0 to about 92 mole percent, from about 13.0 to about 92 mole percent, from about 14.0 to about 92 mole percent, from about 15.0 to about 92 mole percent, from about 16.0 to about 92 mole percent, from about 17.0 to about 92 mole percent, from about 18.0 to about 92 mole percent, from about 19.0 to about 92 mole percent, from about 20.0 to about 92 mole percent, from about 21.0 to about 92 mole percent, from about 22.0 to about 92 mole percent, from about 23.0 to about 92 mole percent, from about 24.0 to about 92 mole percent, from about 25.0 to about 92 mole percent, from about 26.0 to about 92 mole percent, from about 27.0 to about 92 mole percent, from about 28.0 to about 92 mole percent, from about 29.0 to about 92 mole percent, from about 30.0 to about 92 mole percent, from about 31.0 to about 92 mole percent, from about 32.0 to about 92 mole percent, from about 32.0 to about 92 mole percent, from about 33.0 to about 92 mole percent, from about 34.0 to about 92 mole percent, from about 35.0 to about 92 mole percent, from about 36.0 to about 92 mole percent, from about 37.0 to about 92 mole percent, from about 38.0 to about 92 mole percent, from about 39.0 to about 92 mole percent, from about 40.0 to about 92 mole percent, about 0.01 to about 91 mole percent, based on the total moles of sulfur containing compounds, from about 0.1 to about 91 mole percent, from about 1.0 to about 91 mole percent, from about 2.0 to about 91 mole percent, from about 3.0 to about 91 mole percent, from about 4.0 to about 91 mole percent, from about 5.0 to about 91 mole percent, from about 6.0 to about 91 mole percent, from about 7.0 to about 91 mole percent, from about 8.0 to about 91 mole percent, from about 9.0 to about 91 mole percent, from about 10.0 to about 91 mole percent, from about 11.0 to about 91 mole percent, from about 12.0 to about 91 mole percent, from about 13.0 to about 91 mole percent, from about 14.0 to about 91 mole percent, from about 15.0 to about 91 mole percent, from about 16.0 to about 91 mole percent, from about 17.0 to about 91 mole percent, from about 18.0 to about 91 mole percent, from about 19.0 to about 91 mole percent, from about 20.0 to about 91 mole percent, from about 21.0 to about 91 mole percent, from about 22.0 to about 91 mole percent, from about 23.0 to about 91 mole percent, from about 24.0 to about 91 mole percent, from about 25.0 to about 91 mole percent, from about 26.0 to about 91 mole percent, from about 27.0 to about 91 mole percent, from about 28.0 to about 91 mole percent, from about 29.0 to about 91 mole percent, from about 30.0 to about 91 mole percent, from about 31.0 to about 91 mole percent, from about 32.0 to about 91 mole percent, from about 32.0 to about 91 mole percent, from about 33.0 to about 91 mole percent, from about 34.0 to about 91 mole percent, from about 35.0 to about 91 mole percent, from about 36.0 to about 91 mole percent, from about 37.0 to about 91 mole percent, from about 38.0 to about 91 mole percent, from about 39.0 to about 91 mole percent, from about 40.0 to about 91 mole percent, about 0.01 to about 90 mole percent, based on the total moles of sulfur containing compounds, from about 0.1 to about 90 mole percent, from about 1.0 to about 90 mole percent, from about 2.0 to about 90 mole percent, from about 3.0 to about 90 mole percent, from about 4.0 to about 90 mole percent, from about 5.0 to about 90 mole percent, from about 6.0 to about 90 mole percent, from about 7.0 to about 90 mole percent, from about 8.0 to about 90 mole percent, from about 9.0 to about 90 mole percent, from about 10.0 to about 90 mole percent, from about 11.0 to about 90 mole percent, from about 12.0 to about 90 mole percent, from about 13.0 to about 90 mole percent, from about 14.0 to about 90 mole percent, from about 15.0 to about 90 mole percent, from about 16.0 to about 90 mole percent, from about 17.0 to about 90 mole percent, from about 18.0 to about 90 mole percent, from about 19.0 to about 90 mole percent, from about 20.0 to about 90 mole percent, from about 21.0 to about 90 mole percent, from about 22.0 to about 90 mole percent, from about 23.0 to about 90 mole percent, from about 24.0 to about 90 mole percent, from about 25.0 to about 90 mole percent, from about 26.0 to about 90 mole percent, from about 27.0 to about 90 mole percent, from about 28.0 to about 90 mole percent, from about 29.0 to about 90 mole percent, from about 30.0 to about 90 mole percent, from about 31.0 to about 90 mole percent, from about 32.0 to about 90 mole percent, from about 32.0 to about 90 mole percent, from about 33.0 to about 90 mole percent, from about 34.0 to about 90 mole percent, from about 35.0 to about 90 mole percent, from about 36.0 to about 90 mole percent, from about 37.0 to about 90 mole percent, from about 38.0 to about 90 mole percent, from about 39.0 to about 90 mole percent, from about 40.0 to about 90 mole percent.

In other embodiments the sulfonation mixture includes sulfur trioxide ranging from about 0.01 to about 40 mole percent, based on the total moles of sulfur containing compounds in the sulfonation mixture, from about 0.1 to about 40 mole percent, from about 1.0 to about 40 mole percent, from about 2.0 to about 40 mole percent, from about 3.0 to about 40 mole percent, from about 4.0 to about 40 mole percent, from about 5.0 to about 40 mole percent, from about 6.0 to about 40 mole percent, from about 7.0 to about 40 mole percent, from about 8.0 to about 40 mole percent, from about 9.0 to about 40 mole percent, from about 10.0 to about 40 mole percent, from about 11.0 to about 40 mole percent, from about 12.0 to about 40 mole percent, from about 13.0 to about 40 mole percent, from about 14.0 to about 40 mole percent, from about 15.0 to about 40 mole percent, from about 16.0 to about 40 mole percent, from about 17.0 to about 40 mole percent, from about 18.0 to about 40 mole percent, from about 19.0 to about 40 mole percent, from about 20.0 to about 40 mole percent, from about 21.0 to about 40 mole percent, from about 22.0 to about 40 mole percent, from about 23.0 to about 40 mole percent, from about 24.0 to about 40 mole percent, from about 25.0 to about 40 mole percent, from about 26.0 to about 40 mole percent, from about 27.0 to about 40 mole percent, from about 28.0 to about 40 mole percent, from about 29.0 to about 40 mole percent, from about 30.0 to about 40 mole percent, from about 31.0 to about 40 mole percent, from about 32.0 to about 40 mole percent, from about 32.0 to about 40 mole percent, from about 33.0 to about 40 mole percent, from about 34.0 to about 40 mole percent, from about 35.0 to about 40 mole percent, from about 36.0 to about 40 mole percent, from about 37.0 to about 40 mole percent, from about 38.0 to about 40 mole percent, from about 39.0 to about 40 mole percent, about 0.01 to about 39 mole percent, based on the total moles of sulfur containing compounds, from about 0.1 to about 39 mole percent, from about 1.0 to about 39 mole percent, from about 2.0 to about 39 mole percent, from about 3.0 to about 39 mole percent, from about 4.0 to about 39 mole percent, from about 5.0 to about 39 mole percent, from about 6.0 to about 39 mole percent, from about 7.0 to about 39 mole percent, from about 8.0 to about 39 mole percent, from about 9.0 to about 39 mole percent, from about 10.0 to about 39 mole percent, from about 11.0 to about 39 mole percent, from about 12.0 to about 39 mole percent, from about 13.0 to about 39 mole percent, from about 14.0 to about 39 mole percent, from about 15.0 to about 39 mole percent, from about 16.0 to about 39 mole percent, from about 17.0 to about 39 mole percent, from about 18.0 to about 39 mole percent, from about 19.0 to about 39 mole percent, from about 20.0 to about 39 mole percent, from about 21.0 to about 39 mole percent, from about 22.0 to about 39 mole percent, from about 23.0 to about 39 mole percent, from about 24.0 to about 39 mole percent, from about 25.0 to about 39 mole percent, from about 26.0 to about 39 mole percent, from about 27.0 to about 39 mole percent, from about 28.0 to about 39 mole percent, from about 29.0 to about 39 mole percent, from about 30.0 to about 39 mole percent, from about 31.0 to about 39 mole percent, from about 32.0 to about 39 mole percent, from about 32.0 to about 39 mole percent, from about 33.0 to about 39 mole percent, from about 34.0 to about 39 mole percent, from about 35.0 to about 39 mole percent, from about 36.0 to about 39 mole percent, from about 37.0 to about 39 mole percent, from about 38.0 to about 39 mole percent, about 0.01 to about 38 mole percent, based on the total moles of sulfur containing compounds, from about 0.1 to about 38 mole percent, from about 1.0 to about 38 mole percent, from about 2.0 to about 38 mole percent, from about 3.0 to about 38 mole percent, from about 4.0 to about 38 mole percent, from about 5.0 to about 38 mole percent, from about 6.0 to about 38 mole percent, from about 7.0 to about 38 mole percent, from about 8.0 to about 38 mole percent, from about 9.0 to about 38 mole percent, from about 10.0 to about 38 mole percent, from about 11.0 to about 38 mole percent, from about 12.0 to about 38 mole percent, from about 13.0 to about 38 mole percent, from about 14.0 to about 38 mole percent, from about 15.0 to about 38 mole percent, from about 16.0 to about 38 mole percent, from about 17.0 to about 38 mole percent, from about 18.0 to about 38 mole percent, from about 19.0 to about 38 mole percent, from about 20.0 to about 38 mole percent, from about 21.0 to about 38 mole percent, from about 22.0 to about 38 mole percent, from about 23.0 to about 38 mole percent, from about 24.0 to about 38 mole percent, from about 25.0 to about 38 mole percent, from about 26.0 to about 38 mole percent, from about 27.0 to about 38 mole percent, from about 28.0 to about 38 mole percent, from about 29.0 to about 38 mole percent, from about 30.0 to about 38 mole percent, from about 31.0 to about 38 mole percent, from about 32.0 to about 38 mole percent, from about 32.0 to about 38 mole percent, from about 33.0 to about 38 mole percent, from about 34.0 to about 38 mole percent, from about 35.0 to about 38 mole percent, from about 36.0 to about 38 mole percent, from about 37.0 to about 38 mole percent, about 0.01 to about 37 mole percent, based on the total moles of sulfur containing compounds, from about 0.1 to about 37 mole percent, from about 1.0 to about 37 mole percent, from about 2.0 to about 37 mole percent, from about 3.0 to about 37 mole percent, from about 4.0 to about 37 mole percent, from about 5.0 to about 37 mole percent, from about 6.0 to about 37 mole percent, from about 7.0 to about 37 mole percent, from about 8.0 to about 37 mole percent, from about 9.0 to about 37 mole percent, from about 10.0 to about 37 mole percent, from about 11.0 to about 37 mole percent, from about 12.0 to about 37 mole percent, from about 13.0 to about 37 mole percent, from about 14.0 to about 37 mole percent, from about 15.0 to about 37 mole percent, from about 16.0 to about 37 mole percent, from about 17.0 to about 37 mole percent, from about 18.0 to about 37 mole percent, from about 19.0 to about 37 mole percent, from about 20.0 to about 37 mole percent, from about 21.0 to about 37 mole percent, from about 22.0 to about 37 mole percent, from about 23.0 to about 37 mole percent, from about 24.0 to about 37 mole percent, from about 25.0 to about 37 mole percent, from about 26.0 to about 37 mole percent, from about 27.0 to about 37 mole percent, from about 28.0 to about 37 mole percent, from about 29.0 to about 37 mole percent, from about 30.0 to about 37 mole percent, from about 31.0 to about 37 mole percent, from about 32.0 to about 37 mole percent, from about 32.0 to about 37 mole percent, from about 33.0 to about 37 mole percent, from about 34.0 to about 37 mole percent, from about 35.0 to about 37 mole percent, from about 36.0 to about 37 mole percent, from about 37.0 to about, about 0.01 to about 36 mole percent, based on the total moles of sulfur containing compounds, from about 0.1 to about 36 mole percent, from about 1.0 to about 36 mole percent, from about 2.0 to about 36 mole percent, from about 3.0 to about 36 mole percent, from about 4.0 to about 36 mole percent, from about 5.0 to about 36 mole percent, from about 6.0 to about 36 mole percent, from about 7.0 to about 36 mole percent, from about 8.0 to about 36 mole percent, from about 9.0 to about 36 mole percent, from about 10.0 to about 36 mole percent, from about 11.0 to about 36 mole percent, from about 12.0 to about 36 mole percent, from about 13.0 to about 36 mole percent, from about 14.0 to about 36 mole percent, from about 15.0 to about 36 mole percent, from about 16.0 to about 36 mole percent, from about 17.0 to about 36 mole percent, from about 18.0 to about 36 mole percent, from about 19.0 to about 36 mole percent, from about 20.0 to about 36 mole percent, from about 21.0 to about 36 mole percent, from about 22.0 to about 36 mole percent, from about 23.0 to about 36 mole percent, from about 24.0 to about 36 mole percent, from about 25.0 to about 36 mole percent, from about 26.0 to about 36 mole percent, from about 27.0 to about 36 mole percent, from about 28.0 to about 36 mole percent, from about 29.0 to about 36 mole percent, from about 30.0 to about 36 mole percent, from about 31.0 to about 36 mole percent, from about 32.0 to about 36 mole percent, from about 32.0 to about 36 mole percent, from about 33.0 to about 36 mole percent, from about 34.0 to about 36 mole percent, from about 35.0 to about 36 mole percent, from about 0.01 to about 35 mole percent, based on the total moles of sulfur containing compounds, from about 0.1 to about 35 mole percent, from about 1.0 to about 35 mole percent, from about 2.0 to about 35 mole percent, from about 3.0 to about 35 mole percent, from about 4.0 to about 35 mole percent, from about 5.0 to about 35 mole percent, from about 6.0 to about 35 mole percent, from about 7.0 to about 35 mole percent, from about 8.0 to about 35 mole percent, from about 9.0 to about 35 mole percent, from about 10.0 to about 35 mole percent, from about 11.0 to about 35 mole percent, from about 12.0 to about 35 mole percent, from about 13.0 to about 35 mole percent, from about 14.0 to about 35 mole percent, from about 15.0 to about 35 mole percent, from about 16.0 to about 35 mole percent, from about 17.0 to about 35 mole percent, from about 18.0 to about 35 mole percent, from about 19.0 to about 35 mole percent, from about 20.0 to about 35 mole percent, from about 21.0 to about 35 mole percent, from about 22.0 to about 35 mole percent, from about 23.0 to about 35 mole percent, from about 24.0 to about 35 mole percent, from about 25.0 to about 35 mole percent, from about 26.0 to about 35 mole percent, from about 27.0 to about 35 mole percent, from about 28.0 to about 35 mole percent, from about 29.0 to about 35 mole percent, from about 30.0 to about 35 mole percent, from about 31.0 to about 35 mole percent, from about 32.0 to about 35 mole percent, from about 33.0 to about 35 mole percent, from about 34.0 to about 35 mole percent, about 0.01 to about 34 mole percent, based on the total moles of sulfur containing compounds, from about 0.1 to about 34 mole percent, from about 1.0 to about 34 mole percent, from about 2.0 to about 34 mole percent, from about 3.0 to about 34 mole percent, from about 4.0 to about 34 mole percent, from about 5.0 to about 34 mole percent, from about 6.0 to about 34 mole percent, from about 7.0 to about 34 mole percent, from about 8.0 to about 34 mole percent, from about 9.0 to about 34 mole percent, from about 10.0 to about 34 mole percent, from about 11.0 to about 34 mole percent, from about 12.0 to about 34 mole percent, from about 13.0 to about 34 mole percent, from about 14.0 to about 34 mole percent, from about 15.0 to about 34 mole percent, from about 16.0 to about 34 mole percent, from about 17.0 to about 34 mole percent, from about 18.0 to about 34 mole percent, from about 19.0 to about 34 mole percent, from about 20.0 to about 34 mole percent, from about 21.0 to about 34 mole percent, from about 22.0 to about 34 mole percent, from about 23.0 to about 34 mole percent, from about 24.0 to about 34 mole percent, from about 25.0 to about 34 mole percent, from about 26.0 to about 34 mole percent, from about 27.0 to about 34 mole percent, from about 28.0 to about 34 mole percent, from about 29.0 to about 34 mole percent, from about 30.0 to about 34 mole percent, from about 31.0 to about 34 mole percent, from about 32.0 to about 34 mole percent, from about 33.0 to about 34 mole percent, about 0.01 to about 33 mole percent, based on the total moles of sulfur containing compounds, from about 0.1 to about 33 mole percent, from about 1.0 to about 33 mole percent, from about 2.0 to about 33 mole percent, from about 3.0 to about 33 mole percent, from about 4.0 to about 33 mole percent, from about 5.0 to about 33 mole percent, from about 6.0 to about 33 mole percent, from about 7.0 to about 33 mole percent, from about 8.0 to about 33 mole percent, from about 9.0 to about 33 mole percent, from about 10.0 to about 33 mole percent, from about 11.0 to about 33 mole percent, from about 12.0 to about 33 mole percent, from about 13.0 to about 33 mole percent, from about 14.0 to about 33 mole percent, from about 15.0 to about 33 mole percent, from about 16.0 to about 33 mole percent, from about 17.0 to about 33 mole percent, from about 18.0 to about 33 mole percent, from about 19.0 to about 33 mole percent, from about 20.0 to about 33 mole percent, from about 21.0 to about 33 mole percent, from about 22.0 to about 33 mole percent, from about 23.0 to about 33 mole percent, from about 24.0 to about 33 mole percent, from about 25.0 to about 33 mole percent, from about 26.0 to about 33 mole percent, from about 27.0 to about 33 mole percent, from about 28.0 to about 33 mole percent, from about 29.0 to about 33 mole percent, from about 30.0 to about 33 mole percent, from about 31.0 to about 33 mole percent, from about 32.0 to about 33 mole percent, about 0.01 to about 32 mole percent, based on the total moles of sulfur containing compounds, from about 0.1 to about 32 mole percent, from about 1.0 to about 32 mole percent, from about 2.0 to about 32 mole percent, from about 3.0 to about 32 mole percent, from about 4.0 to about 32 mole percent, from about 5.0 to about 32 mole percent, from about 6.0 to about 32 mole percent, from about 7.0 to about 32 mole percent, from about 8.0 to about 32 mole percent, from about 9.0 to about 32 mole percent, from about 10.0 to about 32 mole percent, from about 11.0 to about 32 mole percent, from about 12.0 to about 32 mole percent, from about 13.0 to about 32 mole percent, from about 14.0 to about 32 mole percent, from about 15.0 to about 32 mole percent, from about 16.0 to about 32 mole percent, from about 17.0 to about 32 mole percent, from about 18.0 to about 32 mole percent, from about 19.0 to about 32 mole percent, from about 20.0 to about 32 mole percent, from about 21.0 to about 32 mole percent, from about 22.0 to about 32 mole percent, from about 23.0 to about 32 mole percent, from about 24.0 to about 32 mole percent, from about 25.0 to about 32 mole percent, from about 26.0 to about 32 mole percent, from about 27.0 to about 32 mole percent, from about 28.0 to about 32 mole percent, from about 29.0 to about 32 mole percent, from about 30.0 to about 32 mole percent, from about 31.0 to about 32 mole percent, from about 32.0 to about, from about 0.01 to about 31 mole percent, based on the total moles of sulfur containing compounds, from about 0.1 to about 31 mole percent, from about 1.0 to about 31 mole percent, from about 2.0 to about 31 mole percent, from about 3.0 to about 31 mole percent, from about 4.0 to about 31 mole percent, from about 5.0 to about 31 mole percent, from about 6.0 to about 31 mole percent, from about 7.0 to about 31 mole percent, from about 8.0 to about 31 mole percent, from about 9.0 to about 31 mole percent, from about 10.0 to about 31 mole percent, from about 11.0 to about 31 mole percent, from about 12.0 to about 31 mole percent, from about 13.0 to about 31 mole percent, from about 14.0 to about 31 mole percent, from about 15.0 to about 31 mole percent, from about 16.0 to about 31 mole percent, from about 17.0 to about 31 mole percent, from about 18.0 to about 31 mole percent, from about 19.0 to about 31 mole percent, from about 20.0 to about 31 mole percent, from about 21.0 to about 31 mole percent, from about 22.0 to about 31 mole percent, from about 23.0 to about 31 mole percent, from about 24.0 to about 31 mole percent, from about 25.0 to about 31 mole percent, from about 26.0 to about 31 mole percent, from about 27.0 to about 31 mole percent, from about 28.0 to about 31 mole percent, from about 29.0 to about 31 mole percent, from about 30.0 to about 31 mole percent, from about 0.01 to about 30 mole percent, based on the total moles of sulfur containing compounds, from about 0.1 to about 30 mole percent, from about 1.0 to about 30 mole percent, from about 2.0 to about 30 mole percent, from about 3.0 to about 30 mole percent, from about 4.0 to about 30 mole percent, from about 5.0 to about 30 mole percent, from about 6.0 to about 30 mole percent, from about 7.0 to about 30 mole percent, from about 8.0 to about 30 mole percent, from about 9.0 to about 30 mole percent, from about 10.0 to about 30 mole percent, from about 11.0 to about 30 mole percent, from about 12.0 to about 30 mole percent, from about 13.0 to about 30 mole percent, from about 14.0 to about 30 mole percent, from about 15.0 to about 30 mole percent, from about 16.0 to about 30 mole percent, from about 17.0 to about 30 mole percent, from about 18.0 to about 30 mole percent, from about 19.0 to about 30 mole percent, from about 20.0 to about 30 mole percent, from about 21.0 to about 30 mole percent, from about 22.0 to about 30 mole percent, from about 23.0 to about 30 mole percent, from about 24.0 to about 30 mole percent, from about 25.0 to about 30 mole percent, from about 26.0 to about 30 mole percent, from about 27.0 to about 30 mole percent, from about 28.0 to about 30 mole percent, from about 29.0 to about 30 mole percent, from about 0.5 to about 20 mole percent, from about 1.0 to about 20 mole percent, from about 2.0 to about 20 mole percent, from about 3.0 to about 20 mole percent, from about 4.0 to about 20 mole percent, from about 5.0 to about 20 mole percent, from about 6.0 to about 20 mole percent, from about 7.0 to about 20 mole percent, from about 8.0 to about 20 mole percent, from about 9.0 to about 20 mole percent, from about 10.0 to about 20 mole percent, from about 11.0 to about 20 mole percent, from about 12.0 to about 20 mole percent, from about 13.0 to about 20 mole percent, from about 14.0 to about 20 mole percent, from about 15.0 to about 20 mole percent, from about 16.0 to about 20 mole percent, from about 17.0 to about 20 mole percent, from about 18.0 to about 20 mole percent, from about 19.0 to about 20 mole percent, from about 0.1 to about 1, 2, 3, 4, 5, 6, 7, 8, 9 or 10 percent; from about 1 to about 2, 3, 4, 5, 6, 7, 8, 9 or 10 percent; from about 3 to about 4, 5, 6, 7, 8, 9 or 10 percent; from about 4 to about 5, 6, 7, 8, 9 or 10 percent; from about 5 to about 6, 7, 8, 9 or 10 percent; from about 6 to about 7, 8, 9 or 10 percent; from about 7 to about 8, 9 or 10 percent; from about 8 to about 9 or 10 percent; or from about 9 to about 10 percent. Accordingly, as can be seen from the above description, a concentration or range of concentrations includes not only the beginning and ending numbers but is inclusive of all ranges intermediate the expressed beginning and ending numbers, including any fractions thereof.

In one embodiment, the polyolefin is submerged into or passed through a liquid containing sulfur trioxide or a sulfur trioxide precursor such as chlorosulfonic acid, (HSO₃Cl). In some embodiments, the polyolefin is passed through the liquid by pulling a fiber into the liquid from a reel or spool of fiber either unconstrained or held at a specified tension. Typically, the liquid containing sulfur trioxide is fuming sulfuric acid (i.e., oleum, which typically contains 15-30% free SO₃) or chlorosulfonic acid, or a liquid solution thereof.

In other embodiments, the polyolefin is contacted with a sulfonating gas in a gaseous atmosphere (i.e., not in a liquid). For example, a polyolefin fiber can be introduced into a chamber containing SO₃ gas, or a gaseous reactive precursor thereof, or mixture of the SO₃ gas with another gas as discussed herein.

With respect to the remaining constituents comprising the sulfonation mixture, it may include materials selected from carbon dioxide, nitrogen, argon, helium, sulfur dioxide and the like. Desirably, the remaining constituents comprising the sulfonation mixture include sulfur dioxide. As further described herein, the amount of gaseous SO₃ in the sulfonation mixture may vary depending upon the amount of oxygen introduced in the oxidation step, described herein, to react with SO₂, the amount of SO₃ reacted with the polymer, which in turn may be a function of the amount of SO₃ forming sulfuric acid in the process. As noted above, the SO₃ concentration can be from 0.1 mole % to 100 mole % based on the total moles of the sulfonation mixture, including all ranges there between, and desirably can be from about 0.5 mole % to less than about 10 mole %, or from about 1 mole % to about 5%, based on the total moles of the sulfonation mixture. The amount of SO₃ in the sulfonation mixture may also be varied by modifying, for example, the amount of CO₂ from the sulfonation step that is subsequently removed or left in the process gases, as well as by the amount of SO₂ left unreacted during the oxidation step, as just mentioned.

As used herein, the terms “partially sulfonated,” “partial sulfonation,” “incompletely sulfonated,” or “incomplete sulfonation” are used interchangeably and are defined as an amount of sulfonation below a saturated (or “complete”) level of saturation. The degree of sulfonation can be determined by, for example, measuring the thermal characteristics (e.g., softening or charring point, or decomposition temperature associated with pyrolysis of incompletely sulfonated polyolefin) or physical characteristics (e.g., density, rigidity, or weight fraction of decomposable unsulfonated-polymer segment) of the partially sulfonated polyolefin. Since rigidity, as well as the softening and charring point (and thermal infusibility, in general) all increase with an increase in sulfonation, monitoring of any one or combination of these characteristics can be correlated with a level of sulfonation relative to a saturated level of sulfonation. In particular, the polyolefin, such as a fiber, can be considered to possess a saturated level of sulfonation by exhibiting a constant thermal or physical characteristic with increasing sulfonation treatment time. In contrast, a fiber that has not reached a saturated level of sulfonation will exhibit a change in a thermal or physical characteristic with increasing sulfonation treatment time. Moreover, if the polyolefin with a saturated degree of sulfonation is taken as 100% sulfonated, fibers with a lesser degree of sulfonation can be ascribed a numerical level of sulfonation below 100%, which is commensurate or proportionate with the difference in thermal or physical characteristic between the partially sulfonated fiber and completely sulfonated fiber. In different embodiments, the polyolefin is sulfonated up to or less than a sulfonation degree of 100%, 95%, 90%, 85%, 80%, 75%, 70%, 65%, 60%, 55%, 50%, 45%, 40%, 35%, 30%, 25%, 20%, 15%, 10%, or 5% relative to a saturated level of sulfonation taken as 100%. The level of sulfonation can be further verified or made more accurate by an elemental analysis. The degree of sulfonation (DS) can be determined or monitored at points during the process by use of thermogravimetric analysis (TGA), or other suitable analytical technique.

Accordingly, one skilled in the art would understand that the degree sulfonation of the polyolefin 10 is dependent upon a variety of factors, such as, the amount of time the polyolefin 10 is in contact with the sulfonation mixture 15, the concentration of the sulfur trioxide in the sulfonation mixture 15 and the temperature of the sulfur trioxide in contact with the polyolefin 10. It is understood that sulfur trioxide would be present in a sulfonation mixture of either sulfuric acid, oleum, or a gaseous SO₃ mixture. Although not to be bound by any theory, it is believed that the sulfonation reaction with the polyolefin is as follows:

SO₃+—(C₂H₄)—→—(C₂H₂)—+SO₂+H₂O I

SO₃+H₂O(from equation 1)→H₂SO₄ II

The net reaction of SO₃ with a polyolefin in accordance with the present process produces one mole of SO₂ and one mole of sulfuric acid per double bond generated in the polyolefin. Not wishing to be bound by theory, the individual reactions believed to occur include, in the polymer oxidation (dehydrogenation) step, SO₃ initially reacting with the polymer to form a sulfonated polyolefin. A portion of the sulfonated polyolefin will eliminate SO₂ and water to form a double bond on the polymer. Water subsequently reacts with SO₃ to form H₂SO₄, or sulfuric acid. The net effect is partial sulfonation and partial oxidation of the polyolefin to produce an infusible polymer and reduction of SO₃. The degree of reaction can be manipulated to change the yield and properties of the infusible polymer.

Another advantage of the process of making carbon fibers in accordance with the invention is that the process is energy efficient. The process of the invention does not generate cyanide. Accordingly, there is also provided a process that does not contain an energy source for the destruction of cyanide.

Another advantage of the process of the invention is that coupling sulfur oxidation and reduction a reduced amount of sulfur is consumed compared to the prior art processes that do not integrate sulfur oxidation and reduction. Thus, there is now also provided an integrated sulfur oxidation zone and a sulfur reduction zone. Advantageously, the process of the present invention provides a sulfur efficiency based on the molar ratio of H₂SO₄ produced to sulfur consumed of from about 0.75 to about 1.5, or about 0.75 to 1.25, or about 0.75 to 1.0. As used herein, the term “sulfur consumed” means the amount of sulfur, on an elemental basis, that is converted to a specie or compound that is not readily oxidizable to SO₃. One skilled in the art will understand an immediate advantage of the present invention is that the amount of sulfur utilized in preparing the sulfonation mixture and sulfonating the polyolefin is from about 25% to about 50% less than prior processes utilizing sulfur for making an infusible polyolefin. This efficiency is substantially better than previous methods wherein the SO₂ generated was absorbed, scrubbed or otherwise removed from the process. This further results in economic and energy savings substantially greater than previously realized.

In another embodiment the concentration of sulfur trioxide in the sulfonation mixture 15 is sufficient to react with the polyolefin 10 in the sulfonation reactor 20 to produce a surface temperature of the polyolefin 10 substantially equal to the onset of the polyolefin melting temperature. The onset of the melting temperature of the polyolefin is easily determined by one skilled in the art using differential scanning calorimetry (DSC), on a first scan at a rate of 10° C./min. The onset of melting can be determined by those of skill in analytics and is distinguished from the start of melting. In other embodiments the concentration of sulfur trioxide in the sulfonation mixture is sufficient to react with the polyolefin 10 in the sulfonation reactor 20 to produce a surface temperature of the polyolefin 10 that is more than 25° C. below the onset of the polyolefin melting temperature, or more than 24° C. below the onset of the polyolefin melting temperature, or more than 23° C. below the onset of the polyolefin melting temperature, or more than 22° C. below the onset of the polyolefin melting temperature, or more than 21° C. below the onset of the polyolefin melting temperature, or more than 20° C. below the onset of the polyolefin melting temperature, or more than 19° C. below the onset of the polyolefin melting temperature, or more than 18° C. below the onset of the polyolefin melting temperature, or more than 17° C. below the onset of the polyolefin melting temperature, or more than 16° C. below the onset of the polyolefin melting temperature, or more than 15° C. below the onset of the polyolefin melting temperature, or more than 14° C. below the onset of the polyolefin melting temperature, or more than 13° C. below the onset of the polyolefin melting temperature, or more than 12° C. below the onset of the polyolefin melting temperature, or more than 11° C. below the onset of the polyolefin melting temperature, or more than 10° C. below the onset of the polyolefin melting temperature, or more than 9° C. below the onset of the polyolefin melting temperature, or more than 8° C. below the onset of the polyolefin melting temperature, or more than 7° C. below the onset of the polyolefin melting temperature, or more than 6° C. below the onset of the polyolefin melting temperature, or more than 5° C. below the onset of the polyolefin melting temperature.

In another embodiment the concentration of sulfur trioxide in the sulfonation mixture 15 is sufficient to react with the polyolefin 10 in the sulfonation reactor 20 to produce a surface temperature of the polyolefin 10 that is from about 5° C. to about 25° C. less than the onset of the polyolefin melting temperature; from about 6° C. to about 25° C. less than the onset of the polyolefin melting temperature; from about 7° C. to about 25° C. less than the onset of the polyolefin melting temperature; from about 8° C. to about 25° C. less than the onset of the polyolefin melting temperature; from about 7° C. to about 25° C. less than the onset of the polyolefin melting temperature; from about 6° C. to about 25° C. less than the onset of the polyolefin melting temperature; from about 7° C. to about 25° C. less than the onset of the polyolefin melting temperature; from about 8° C. to about 25° C. less than the onset of the polyolefin melting temperature; from about 9° C. to about 25° C. less than the onset of the polyolefin melting temperature; from about 10° C. to about 25° C. less than the onset of the polyolefin melting temperature; from about 11° C. to about 25° C. less than the onset of the polyolefin melting temperature; from about 12° C. to about 25° C. less than the onset of the polyolefin melting temperature; from about 13° C. to about 25° C. less than the onset of the polyolefin melting temperature; from about 14° C. to about 25° C. less than the onset of the polyolefin melting temperature; from about 15° C. to about 25° C. less than the onset of the polyolefin melting temperature; from about 16° C. to about 25° C.; from about 17° C. to about 25° C. less than the onset of the polyolefin melting temperature; from about 18° C. to about 25° C. less than the onset of the polyolefin melting temperature; from about 19° C. to about 25° C. less than the onset of the polyolefin melting temperature; from about 20° C. to about 25° C. less than the onset of the polyolefin melting temperature; or from about 21° C. to about 25° C. less than the onset of the polyolefin melting temperature.

Exiting the sulfonation reactor 20 is an infusible polymer 25 and a recovery stream 30. The recovery stream 30 includes sulfur dioxide and may further include unreacted sulfur trioxide and carbon dioxide. The amount of gaseous carbon dioxide in the gaseous sulfonation mixture of step (a) may, in part, be a function of the amount of polyolefin reacted with O₂ during the contacting of the polyolefin with the sulfonation mixture, reduced by any amount of CO₂ afterward removed prior to or following the reacting of the gaseous mixture of SO₂ and CO₂ obtained from step (a) with the O₂, or increased by the amount of CO₂ intentionally added to reduce the total sulfur trioxide content in the recirculating stream 100. The amount of CO₂ can be from about 0% to about 5%, or 10%, or 15%, or 20%, or 25%, or 30%, or 35%, or 40%, or 45%, or 50%, or 55%, or 60%, or 65%, or 70%, or 75%, or 80%, or 85%, or 90.9%, or 95% or 99.7% by volume of the recirculating stream 100.

The recovery stream 30 can optionally be passed through a dewater scrubber 40 to dehydrate the SO₂ and remove a deleterious portion of water that may be present in the recovery stream 30 prior to oxidizing at least a portion of the SO₂ in the oxidizer 70. The concentration of SO₂ present during the oxidation step described herein may be selected so as to maintain a predetermined temperature during the oxidation of SO₂ to SO₃. In removing any water from the recovery stream 30, at least a portion of the stream is contacted with a dehydrating agent, such as sulfuric acid having a H₂SO₄ concentration of greater than about: 90%, or 92%, or 93%, or 94%, or 95%, or 96%, or 97%, or 98%, or 99%. The portion of the recovery stream 30 contacted with the dehydrating agent can be from about 1%, 10%, 15%, 20%, 25%, 30%, 35%, 40%, 45%, 50%, 55%, 60%, 65%, 70%, 75%, 80%, 85%, 90%, 95%, or 100%.

A dry or essentially dry recycle stream 60 exits the dewater scrubber 40 having sulfur dioxide and may further include sulfur trioxide and carbon dioxide. At least a portion of the dry recycle stream 60 is fed to a sulfur oxidizer 70. The portion of the dry recycle stream 60 fed to the sulfur oxidizer can be from about 0.1 to about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 30%, 41%, 42%, 43%, 44%, 45%, 46%, 47%, 48%, 49%, 40%, 51%, 52%, 53%, 54%, 55%, 56%, 57%, 58%, 59%, 50%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or 100%.

If desired, the portion of the recycle stream 60 not fed to the sulfur oxidizer 70 or otherwise treated may be directed to a preselected side stream 55 or can bypass the oxidizer 70 and be directed to the enriched recycle stream 100 via line 65, bypassing the sulfur oxidizer 70. One advantage to directing at least a portion of the dry recycle stream 60 to the enriched recycle stream 100 is that the concentration of sulfur trioxide in the enriched recycle stream can be more easily controlled to a desired predetermined concentration. This would further allow a greater control of the reaction rate between sulfur trioxide and the polyolefin to prevent overheating and allow greater control of the degree of sulfonation of the polymer.

If desired, a portion of the CO₂ present in the recycle stream 60 exiting the dewater scrubber 40 may be removed via line 55 and be recovered using techniques known to those skilled in the art or otherwise removed from the process. The portion of the CO₂ removed from the recycle stream 60 can be from about 0% to about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 30%, 41%, 42%, 43%, 44%, 45%, 46%, 47%, 48%, 49%, 40%, 51%, 52%, 53%, 54%, 55%, 56%, 57%, 58%, 59%, 50%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or 100%.

The recycle stream 60 containing SO₂ is then fed to an oxidizer for contacting an oxygen-containing gas and optionally, a sulfur-containing compound. The oxygen-containing gas and optionally, a sulfur-containing compound enter the oxidizer via line 80 and line 90, respectively to produce an enriched SO₃ recycle stream 100. Up to 100% of this enriched SO₃ recycle stream 100 is then combined with the sulfonation mixture 15 for contacting the polyolefin to produce an infusible polyolefin. In some embodiments, from about 1% up to 100% of the SO₃ utilized in the sulfonation mixture is from the enriched recycle stream, or from about 1% up to 95%, or from about 1% up to 90%, or from about 1% up to 85%, or from about 1% up to 80%, or from about 1% up to 75%, or from about 1% up to 70%, or from about 1% up to 65%, or from about 1% up to 60%, or from about 1% up to 55%, or from about 1% up to 50%, or from about 1% up to 45%, or from about 1% up to 40%, or from about 1% up to 35%, or from about 1% up to 30%, or from about 1% up to 25%, or from about 1% up to 20%, or from about 1% up to 15%, or from about 1% up to 10%, or from about 1% up to 5% of the SO₃ utilized in the sulfonation mixture is from the enriched recycle stream, or any other range inclusive between any two of the above delineated ranges.

In another embodiment, the oxygen containing gas is dry air, which when contacted with the SO₂ in the oxidizer 70 produces an enriched recycle stream 100 having a SO₃ content that greater than the SO₃ content in the recycle stream 60. Moreover, using air as the oxygen containing stream may further necessitate the removal or scrubbing of at least a portion of CO₂, N₂, NOₓ specie, and other trace inert gases present using optional scrubber 75 and removing at least a portion of CO₂, N₂, NOₓ specie, and other trace inert gases present via line 110 to a predetermined concentration prior to combining the enriched recycle stream 100 with the sulfonation mixture 15 entering the sulfonation reactor 20. The amount of the CO₂, N₂, NOₓ specie, and other trace gases removed from the recycle stream can be from about 0% to about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 30%, 41%, 42%, 43%, 44%, 45%, 46%, 47%, 48%, 49%, 40%, 51%, 52%, 53%, 54%, 55%, 56%, 57%, 58%, 59%, 50%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or 100% based on the total of the specie removed. For example, it may be desirable to remove 100% of the NOₓ specie, less than 100% of the N₂ present, and 0% of the CO₂ generated during oxidization.

Methods and apparatus used for producing SO₃ by burning a sulfur-containing compound in the presence of an oxygen-containing gas are well known in the art of producing sulfur trioxide. For example, Kirk-Othmer Encyclopedia of Chemical Technology, 5^{th} ed., vol. 23 provides a detailed description of single-pass SO₃ absorption and multiple-pass SO₃ absorption processes, the entire disclosure of which is incorporated herein by reference.

Generally,

SO₂+0.5O₂←→SO₃. III

There are three important characteristics in oxidizing sulfur dioxide to sulfur trioxide; it is exothermic, reversible, and shows a decrease in molar volume for the desired product, SO₃. To improve equilibrium for the reaction, past practices have used different methodologies, such as increasing the concentration of SO₂, increasing the concentration of O₂, and removing the SO₃ by interpass absorption to name a few. In a single pass absorption process the SO₂ is oxidized to SO₃ in a multipass converter. Gas leaving the converter passes through a single SO₃ absorption tower. In a multiple pass process intermediate SO₃ absorption takes place after the second or third converter pass.

Advantageously, the process of the present invention does not require complete oxidation of the sulfur dioxide to produce sulfur trioxide. Partial oxidation allows for economy of scale and allows for the sulfur dioxide to act a diluent. Thus, a single pass oxidation is now achievable rather than utilizing a multi-pass converter.

Sulfur dioxide gas is catalytically oxidized to sulfur trioxide in a fixed-bed reactor that typically operates adiabatically in each catalyst pass. To obtain optimum conversion, the heat of reaction from succeeding converter passes is removed by superheaters or gas heat exchangers. The gas temperature rise is almost directly proportional to the sulfur dioxide converted in each pass even though SO₂ and O₂ concentrations can vary widely.

In oleum manufacture, SO₃ is absorbed into sulfuric acid using one or more special absorption towers irrigated by recirculated oleum. Generally, the amount of SO₃ that can be absorbed from the process gas is up to about 70% due to the vapor pressure of the sulfur trioxide.

Thus, in accordance with the present invention, by utilizing a SO₂ oxidation step, a portion of the SO₂ produced in the polymer sulfonation step is oxidized with O₂ to form SO₃, which in turn is used as a reactant to produce the infusible polyolefin. The SO₃ utilized is returned to the reactor in mixture with additional circulating SO₂, and optionally CO₂, as a diluent. This novel additional recirculating SO₂ allows complete conversion of the differential SO₂ generated by the last pass of the gas through the sulfonation reactor 20, and complete consumption of the oxygen because there is a stochiometric excess of SO₂ in the oxidizer to drive the reversible reaction forward.

The present process is advantageous over prior art processes which require combining the SO₃ with water (usually in the form of 93-98% sulfuric acid) to form additional sulfuric acid in order to consume substantially all of the SO₂ generated in the sulfonation reactor 20. In the prior art processes, the net reaction of SO₃ with polyolefin without SO₂ recycle would produce substantially more and at least about twice as much sulfuric acid. That is, only partial conversion of the SO₂ would occur because of the reaction equilibrium. To drive the reaction to completion as required to reduce the SO₂ level to a permissible vent discharge concentration, the SO₃-containing gas stream would have to be scrubbed with water which creates additional sulfuric acid as a consequence.

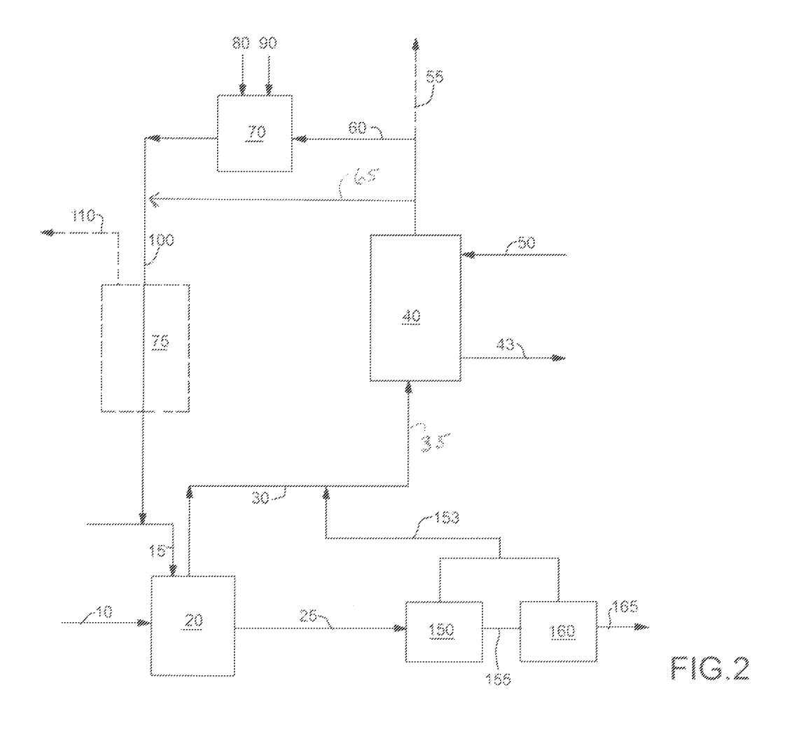

Referring to FIG. 2 another aspect of the present invention is illustrated, a process for making a carbon fiber from the infusible fiber described above. The process includes the steps of (a) contacting a polyolefin 10 in a sulfonation reactor 20 with a sulfonation mixture 15 having sulfur trioxide to produce an infusible polyolefin 25; (b) recovering from the sulfonation reactor 20 a first recovery stream 30 having sulfur dioxide; (c) oxidizing at least a portion of the sulfur dioxide in the recovery stream 30 in an oxidizer 70 to produce an enriched recycle stream 100 so that the enriched recycle stream 100 has an increased concentration of sulfur trioxide, relative to the recovery stream 30; (d) combining at least a portion of the enriched recycle 100 stream with the sulfonation mixture 15 of step (a) and (e) carbonizing the infusible polyolefin to produce a carbon fiber 165.

It is to be understood that the process steps (a)-(d), inclusive are the same as previously described with reference to FIG. 1 above, the description of which is incorporated herein with respect to FIG. 2 such that in the drawings of Figures, like parts and objects in the several views have similar reference numerals. The infusible polyolefin 25 is heated to produce a carbon fiber. Carbonizing the infusible polyolefin may be performed in a single heating step or may be carried out in a plurality of heating steps, where each successive heating step involves subjecting the infusible polyolefin to a greater temperature than the preceding heating step. In accordance with the present invention, the carbonizing step includes introducing the infusible polyolefin to a low temperature desulfonation oven 150. The temperature in the desulfonation oven 150 can independently be selected from any of the sulfonation temperatures and residence times provided above (e.g., from about 30° C., 40° C., 50° C., 60° C., 70° C., 80° C., 90° C., 100° C., 110° C., 120° C., 130° C., 140° C., 150° C., 160° C., 170° C., 180° C., 190° C., 200° C., 210° C., 220° C., 230° C., 240° C., 250° C., 260° C., 270° C., 280° C., 290° C., or 300° C.,). Moreover, a desulfonation process is generally practiced herein in the absence of an external sulfonating source, thereby not further adding sulfonating species to the infusible polyolefin, but limiting the amount of sulfonating species to the amount present in the sulfonated surface or the amount incorporated into polymer fiber for a melt-mixed fiber. The desulfonation process may include introducing an oxygen-containing compound, such as air, or may be practiced in an artificial oxygen-inert gas atmosphere, which may be conducted at either standard pressure (e.g., 0.9-1.2 bar), elevated pressure (e.g., 2-10 bar), or reduced pressure (e.g., 0.1-0.5 bar). In other embodiments, a pressure of precisely, about, or at least 0.1, 0.2, 0.5, 1, 2, 3, 4, 5, 6, 7, 8, 9, or 10 bar, or a pressure within a range therein, is employed.

In some embodiments, the desulfonation process includes exposing the infusible polyolefin (before, during, and/or after the sulfonation or desulfonation process) to radiative energy. The radiative energy can be, for example, electromagnetic radiation (e.g., ultraviolet, X-ray, infrared, or microwave radiation) or energetic particles (e.g., electron or neutron beam). In the case of electromagnetic radiation, the radiation may be dispersed or collimated, as in a laser. In some embodiments, the radiative energy is ionizing, while in other embodiments it is not ionizing. The fiber may alternatively or additionally be exposed to radiative energy before, during, or after sulfonation and/or carbonization. In some embodiments, electromagnetic or energetic particle radiation is not employed.

The infusible polyolefin is then carbonized by subjecting it to carbonizing conditions in a carbonization step. The carbonization step includes any of the conditions, as known in the art, that cause carbonization of the sulfonated polymer. Generally, in different embodiments, the carbonization temperature can be about, or at least 300° C., 350° C., 400° C., 450° C., 500° C., 550° C., 600° C., 650° C., 700° C., 750° C., 800° C., 850° C., 900° C., 950° C., 1000° C., 1050° C., 1100° C., 1150° C., 1200° C., 1250° C., 1300° C., 1350° C., 1400° C., 1450° C., 1500° C., 1600° C., 1700° C., or 1800° C., or a temperature within a range bounded by any two of the foregoing temperatures. The amount of time that the sulfonated polyolefin is subjected to the carbonization temperature (i.e., carbonization time) is highly dependent on the carbonization temperature employed. Generally, the higher the carbonization temperature employed, the shorter the amount of time required. In different embodiments, depending on the carbonization temperature and other factors (e.g., pressure), the carbonization time can be, for example, about, at least, or no more than 0.02, 0.05, 0.1, 0.125, 0.25, 0.5, 1, 2, 3, 4, 5, 6, 7, 8, 9, 10, 11, or 12 hours, or within a range therein. In particular embodiments, it may be desired to gradually raise the temperature at a set or varied temperature ramp rate (e.g., 5° C./min, 10° C./min, or 20° C./min). In other embodiments, it may be desired to pass the sulfonated polymer through a furnace with a gradient of temperature at the entrance and exit of the furnace and at a set temperature inside the furnace in order to achieve the desired residence time. In other embodiments, it may be desired to subject the sulfonated polymer to a sudden (i.e., non-gradual) carbonization temperature. In some embodiments, after the sulfonated polyolefin is subjected to a desired carbonization temperature for a particular amount of time, the temperature is reduced either gradually or suddenly.

In the desulfonation and carbonization process, sulfur dioxide is released and recovered via a second recovery stream 153 which may also contain water and carbon dioxide. The amount of gaseous sulfur dioxide in the second recovery stream 153 may, in part, be a function of the amount of polyolefin reacted with SO₃ during the contacting of the polyolefin with the sulfonation mixture. The second recovery stream 153 and first recovery steam 30 are combined to form a combined recovery stream 35. As noted above, the combined recovery stream 35, can optionally be passed through a dewater scrubber 40 to dehydrate the SO₂ and remove a deleterious portion of water that may be present in the combined recovery stream 35 prior to oxidizing at least a portion of the SO₂ in the oxidizer 70. The concentration of SO₂ present during the oxidation step described herein may be selected so as to maintain a predetermined temperature during the oxidation of SO₂ to SO₃. In removing any water from the combined recovery stream 35, at least a portion of stream 35 is contacted with a dehydrating agent, such as sulfuric acid having a H₂SO₄ concentration of greater than about: 90%, or 92%, or 93%, or 94%, or 95%, or 96%, or 97%, or 98%, or 99%. The portion of stream 35 contacted with the dehydrating agent can be from about 1%, 10%, 15%, 20%, 25%, 30%, 35%, 40%, 45%, 50%, 55%, 60%, 65%, 70%, 75%, 80%, 85%, 90%, 95%, or 100%.

One skilled in the art will recognize that the carbonized polyolefin may be further subjected to an elevated temperature to produce a graphitized carbon fiber. Typically, the temperature capable of causing graphitization is greater than about 2000° C., 2100° C., 2200° C., 2300° C., 2400° C., 2500° C., 2600° C., 2700° C., 2800° C., 2900° C., 3000° C., 3100° C., or 3200° C., or a range between any two of these temperatures.

The carbonization or graphitization step may be conducted in an atmosphere substantially devoid of a reactive gas (e.g., oxygen or hydrogen), and typically under an inert atmosphere. Some examples of inert atmospheres include nitrogen and the noble gases (e.g., helium or argon). The inert gas is generally made to flow at a specified flow rate, such as 0.1, 0.25, 0.50, 1, 5, 10, 20, or 30 Liters/min. However, one or more reactive functionalizing species may be included in the carbonization step or in a post-treatment step (e.g., at the exit of the furnace as a post-carbonization step) to suitably functionalize the carbon fiber, e.g., by inclusion of a fluorocarbon compound to induce fluorination, or inclusion of an oxygen-containing species to induce oxygenation (to include, e.g., hydroxy or ether groups), or inclusion of amino-, thio-, or phosphino-species to aminate, thiolate, or phosphinate the carbon fiber. Thus, in some embodiments, it may be preferred to include at least one reactive gas, such as oxygen, hydrogen, ammonia, an organoamine, carbon dioxide, methane, a fluoroalkane, a phosphine, or a mercaptan. The one or more reactive gases may, for example, desirably change or adjust the compositional, structural, or physical characteristics of the carbon fiber. The functionalized groups on the carbon fiber can have a variety of functions, e.g., to bind to metal species that are catalytically active, or to modify or adjust the surface miscibility, absorptive, or wetability characteristics, particularly for gas absorption and filtration applications.

The pressure employed in the carbonization (or graphitization) step is typically ambient (e.g., around 1 atm). However, in some embodiments it may desirable to use a higher pressure (e.g., above 1 atm, such as 1.5, 2, 5, 10, 20, 50, or 100 atm, or any pressure within a range between any two specified pressures) to, for example, maintain a positive pressure inside the furnace and keep the sample free of oxygen at high temperature to avoid combustion or partial combustion. In other embodiments, it may be desired to use a lower pressure (e.g., below 1 atmosphere, such as 0.5, 0.1, 0.05, or 0.01 atmosphere, or any pressure within a range between any two specified pressures).

On skilled in the art will understand that the polyolefin to be sulfonated and/or carbonized may be in the form of a fiber, tow, mesh, or in another form (e.g., film, block, ring, tube, or woven or non-woven mat) depending on the predetermined application of the polyolefin composition.

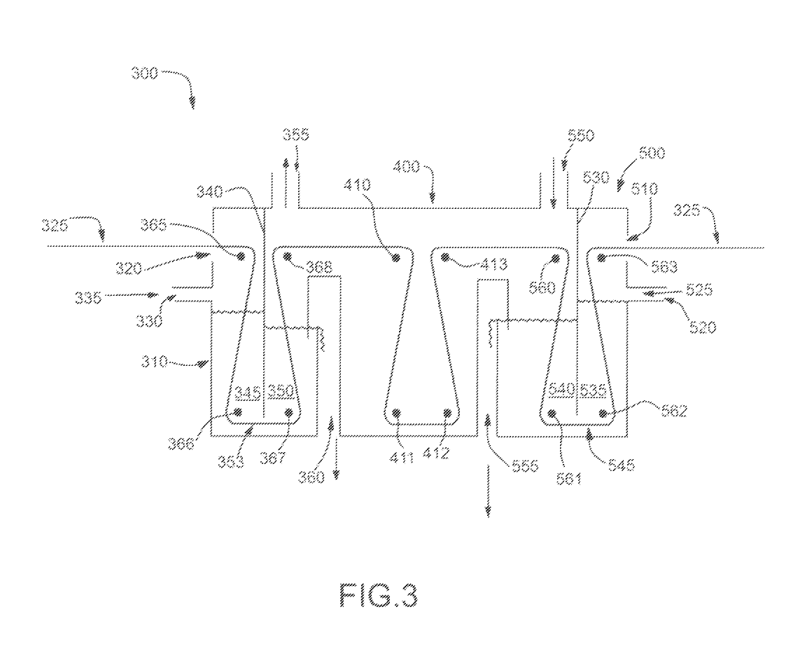

Referring to FIG. 3, an apparatus 300 for preparing an infusible polyolefin is illustrated having a plurality of compartments adapted to be in fluid communication. A first compartment 310 includes a first inlet, opening or orifice 320 that is adapted for allowing a polyolefin precursor strand 325 to enter the first compartment 310. The first compartment 310 further includes a second opening 330 for allowing a first fluid 335 to enter the first compartment 310. The first compartment 310 has a first partial divider or partitioning means 340 extending downwardly so as to subdivide the first compartment 310 into a first liquid holding portion 345 and a second liquid holding portion 350, and further defines a first partition opening 353 so that the first and second liquid holding portions 345 and 350 are in liquid communication. Positioned adjacent to the second liquid holding portion 350 is a means for venting vapor 355 from the apparatus 300. Desirably, the first divider means 340 is positioned so that vapors within the apparatus 300 do not enter the first liquid holding portion 345 of the first compartment 310, thereby forming a liquid seal or trap to prevent vapor from escaping from openings 320 and 330 of the first compartment 310. The second liquid holding portion 350 includes a first liquid level control means 360 for controlling the liquid level in the first compartment 310. Such control means are well known in the art and include manual and automatic control valves, weirs, control orifices, liquid traps, and the like.

A plurality of guide and/or tension rollers 365-368 retain the polyolefin strand 325 in alignment and guide the polyolefin strand 325 downwardly into the first portion 345, through the partition opening 353 and upwardly to a second compartment 400. The guide and/or tension rollers 365 can be fixed or adjustable so as to maintain a predetermined tension on the strand during the process.

Adjacent to and in fluid communication with the first compartment 310 is a second compartment 400 that is adapted to expose the polyolefin to a vaporous environment. The second compartment 400 includes a plurality of guide and/or tension rollers 410-413 to retain the polyolefin strand 325 in alignment and guide the polyolefin strand 325 downwardly into the second compartment 400 and upwardly to a third compartment 500. Desirably, guide and/or tension rollers are adjustable so as to maintain a predetermined tension on the strand during the process and to readily adjust the contact time of the strand in a sulfonation environment.

Adjacent to and in fluid communication with the second compartment 400 is a third compartment 500.

The third compartment 500 includes a second opening or orifice 510 that is adapted for allowing a polyolefin precursor strand 325 to exit the third compartment 500. The third compartment 500 includes a third opening 520 for allowing a second fluid 525 to enter the third compartment 500. The third compartment 500 has a second partial divider or partitioning means 530 extending downwardly so as to subdivide the third compartment 500 into a third liquid holding portion 535 and a forth liquid holding portion 540, and further defines an opening 545 so that the third and forth liquid holding portions 535 and 540 are in liquid communication. Positioned adjacent to the forth liquid holding portion 540 is a means introducing a vapor 550 into the apparatus 300. Desirably, the second partial divider means 530 is positioned so that vapors within the apparatus 300 do not enter the third liquid holding portion 535 of the third compartment 500, thereby forming a liquid seal or trap to prevent vapor from escaping from openings 510 and 520 of the third compartment 500. The forth liquid holding portion 540 includes a second liquid level control means 555 for controlling the liquid level in the third compartment 500. Such control means are well known in the art and include manual and automatic control valves, weirs, control orifices, liquid traps, and the like.

A plurality of guide and/or tension rollers 560 retain the polyolefin strand 325 in alignment and guide the polyolefin strand 325 downwardly into the forth portion 540, through the second partition opening 545 and upwardly through the third partition 535 and then out via opening 510. The guide and/or tension rollers 560-563 can be fixed or adjustable so as to maintain a predetermined tension on the strand during the process.

In making an infusible fiber or strand, a polyolefin strand 325 is drawn into the first compartment 310 through the first opening 320 and over roller/tensioner 365 and downwardly into a first liquid in the first liquid holding portion 345. The strand 325 passes under roller 366 through the first partition opening 353 into the second liquid holding portion 350 and under roller 367. The strand 325 then travels upwardly and over roller 368. To pretreat the strand 325 the first liquid can be one of the sulfur-containing liquids described herein or can be an inert liquid.

The strand 325 is then transferred to the second compartment 400. The strand 325 is subjected to a vaporous environment as the strand 325 serpentines over the guide and/or tension rollers 410-413.

A fluidic sulfonation mixture enters via line 550. The contact time of the polyolefin strand 325 and the fluidic sulfonation mixture can be adjusted by adjusting the moveable rollers 410-413 in the second compartment 400. The fluidic sulfonation mixture exits via line 355.

The strand 325 is then transferred to the third compartment 500 over roller/tensioner 560. The strand 325 travels downwardly into the third liquid holding portion 535. The strand 325 passes under roller 561 and through the second partition opening 545 and under roller 562. The infusible polymer strand 325 then travels upwardly and over roller 563 and exits the apparatus 300 via line 510. A second liquid enters the third compartment 500 via line 525. The second liquid can be one of the sulfur-containing liquids described herein or can be an inert liquid. The infusible polymer can be subjected to immediate carbonization or may be spooled for future use in making a carbon fiber.

The present invention is illustrated in greater detail by the specific examples presented below. It is to be understood that these examples are illustrative embodiments and are not intended to be limiting of the invention, but rather are to be construed broadly within the scope and content of the appended claims. All parts and percentages in the examples are on a weight basis unless otherwise stated.

### Example 1

Reaction of polyethylene, polyisoprene, trans, and poly(vinyl alcohol-co-ethylene) with vapor phase SO₃ diluted with inert gas and contact times of up to 60 seconds.

A fully jacketed 2 liter glass reactor fitted with a silicone oil circulation bath was used to run both vapor phase and liquid phase sulfonation/dehydrogenation reactions. The apparatus is fitted with thermocouples for measuring both liquid and gas phase temperature, along with a nitrogen purge line, vapor trap to scrub SO₃ vapor, and bottom drain to facilitate quenching of oleum into a wet ice bath at in completion of the reaction. The reactor has three 24/40 ground glass fittings (ports) to permit placing samples into the gas or liquid phase. The ports are closed with glass stopper when not in use for sample exposure. The sample hangers are 24/40 glass stoppers fitted with a glass rod. Each rod has two hooks to allow placement of 2 test samples on each sample hanger. Two small gauge wire holders were fitted to each hanger to hold the samples onto the hanger while exposure of the sample to the SO₃ vapor space.

Polymer test strips were prepared by pressing a small sample of the desired polymer between polished stainless steel plates treated with a silicone release agent. A hydrolytic press with heated platens was used to press the samples. A 6 mil×2.5″×2.5″ spacer was used to control sample thickness size. After pressing, the samples were quenched in an ice bath and cut into approximately 1 cm×4 cm strips. See Table 1 for polymer description and source of polymers.

TABLE 1

| Polymer Type | Source | Density | | Description |
|---|---|---|---|---|
| Polyethylene | Westlake | 0.92 | g/mL | Low density MI 1.0 |
| | Chemical | | | |
| Polyisoprene, | Sigman- | 0.904 | g/ml | 99 + % trans - 1,4 Tm - |
| Trans | Aldrich | | | 60° C.; Tg - 68° C. |
| Poly(vinyl | Sigman- | 1.14 | g/ml | Ethylene 44 mol %, Tg - |
| alcohol | Aldrich | | | 55° C.; MI 3.5 g/10 min at |
| co-ethylene) | | | | 210° C. |

The concentration of sulfur trioxide in the vapor phase was determined to be about 4.8-5.3% at a temperature of about 80-82° C. as determined by fluid phase equilibrium.

A clean and dry reaction vessel as described above was setup in a hood with minimum air face velocity of 110 feet per minute (fpm). The reactor was purged with nitrogen for 45 minutes with 1 standard cubic foot per hour (SCFH (>10 volume turnover)). The wet trap was charged with 50% caustic and wet ice. The reactor was then charged with 374 g of 20% oleum. A nitrogen gas flow rate was set at 0.05 SCFH and the reactor was heated to 80° C. with silicone oil in circulating jacket. This gave an SO₃ concentration in the gas phase of approximately 5%.

Samples of linear low density polyethylene, polyisoprene, trans, and poly(vinyl alcohol-co-ethylene) test strips were prepared as described above. The samples were placed onto sample hangers and exposed to SO₃ vapor for 5, 15 and 60 second time intervals. Changes in weight and appearance are shown in Table 2 below.

TABLE 2

| Sample | | Initial Wt. | Exposure | Final Wt. | % Wt. |
|---|---|---|---|---|---|
| No. | Polymer Type | (grams) | Time (sec.) | (grams) | Increase |
| 1 | polyisoprene | 0.0848 | 5 | 0.0858 | 1% |
| 2 | polyisoprene | 0.0775 | 60 | 0.0822 | 6% |
| 3 | polyethylene | 0.0811 | 15 | 0.091 | 12% |
| 4 | polyethylene | 0.0744 | 60 | 0.0918 | 23% |
| 5 | Poly(vinyl | 0.0871 | 60 | 0.0908 | 4% |
| | alcohol | | | | |
| | co-ethylene) | | | | |

Observations for each sample were as follows:
1. Sample turned blackish brown in 2 seconds. Removed sample after 5 seconds and observed shrinkage of film.
2. Sample turned black in 5 seconds. Some shrinkage of film.
3. Sample turned yellow, then brown and finally black in about 15 seconds. No film shrinkage occurred.
4. Sample turned yellow in 5 seconds and appeared shiny opaque when withdrawn at the end of 60 seconds.
5. Sample turned yellow in 5 seconds, dark grey in 15 seconds, light black in 45 seconds and dull black in 60 seconds. No film shrinkage was observed.

A sample of the unreacted polyethylene, and reacted samples 3-5 were analyzed by IR to determine extent of sulfonation and dehydrogenation. IR spectra were acquired with a Nicolet 6700 FT-IR with an ATR accessory using a Si crystal (128 scans, 4 cm-1 resolution). This technique is a surface technique that penetrates typically less than one micron into the sample.

The change in appearance of the samples, color turning from clear to black, indicates that sulfonation and elimination of SO₂ and water to from conjugated double bonds is very fast in the gas phase at 80° C. This observation is supported by the IR data. As can be seen from Sample 3, after 15 seconds of exposure almost complete reaction of CH₂ groups on the surface of the polyethylene occurred as observed by the sample turning black.

Advantageously, the present invention demonstrates a dramatic improvement results previously reported by D. Zhang, et al. Journal Applied Polymer Science, Vol. 62, 367-373 (1996). They found that partially oriented PE required 15 minutes to turn dark grey, and 30 min to turn black when exposed to concentrated (95%) sulfuric acid at 130° C. The present invention advantageously provides a greater than an order of magnitude increase in rate of color change (15 seconds vs. 900 seconds for Zhang et. al.) while running at a significantly lower temperature (80° C. vs. 130° C.).

Additionally, it was unexpected discovered that starting with a polyolefin with unsaturation such as polyisoprene, trans, results in an even faster rate of reaction, as indicated by color change. Polyisoprene, trans turned black in 5 seconds vs. 15 seconds for polyethylene, with reaction at the same conditions of 4.8-5.3% SO₃ in the gas phase, and 80° C.

### Example 2

Reaction of polyethylene and polyisoprene, trans with vapor phase sulfur trioxide diluted with inert gas with contacts times up to 100 minutes.

The reactor as used in Example 1 above was setup under a hood having a minimum air face velocity of 110 feet per minute. The reactor was purged with nitrogen for 45 minutes with 1 SCFH (>10 volume turnover). The wet trap was charged with 50% caustic and wet ice. The reactor was then charged with 349 grams of 20% oleum. The nitrogen gas flow rate was set at 0.05 SCFH and the reactor is heated to 80° C. with silicone oil in circulating jacket. This will give a sulfur trioxide concentration in the gas phase of approximately 5%.

Samples of linear low density polyethylene (Samples 6-11) and polyisoprene, trans (Samples 12-17) test strips were prepared as described above. The samples were placed onto sample hangers and exposed to SO₃ vapor for 1, 5, 10, 50, and 100 minute time intervals. Changes in weight and appearance are recorded in Table 3 below.

TABLE 3

| | Initial | Exposure | | | Wt. loss at | |
|---|---|---|---|---|---|---|
| Sample | Wt. | Time | Final Wt. | % Wt. | 300° C. from | * Carbonized |
| No. | (grams) | (min.) | (grams) | Change | TGA 10° C./min N₂ | product |
| 6 | | 0 | | | 1.4 | 0 |
| 7 | 0.0885 | 1 | 0.1059 | 20 | 6 | 3.84 |
| 8 | 0.1038 | 5 | 0.1419 | 37 | 15 | 4 |
| 9 | 0.0893 | 10 | 0.1265 | 42 | 26 | 7 |
| 10 | 0.0977 | 50 | 0.2687 | 175 | 61 | 26 |
| 11 | 0.1089 | 100 | 0.427 | 293 | | |
| 12 | NA | 0 | NA | 0 | 1.47 | 0 |
| 13 | 0.0956 | 1 | 0.1036 | 8 | 5 | 0 |
| 14 | 0.0852 | 5 | 0.1016 | 19 | 11 | 1 |
| 15 | 0.0985 | 10 | 0.1486 | 51 | 34 | 11 |
| 16 | 0.0745 | 50 | 0.1236 | 66 | 38 | 16 |
| 17 | 0.1036 | 100 | 0.2881 | 178 | | |

* % weight retained of original sample after heating to 600° C. in TGA 10° C./min under N₂ purge.

Observations for each sample were as follows:
6. Unreacted starting material TGA.
7. A little liquid present on the surface.
8. A little liquid present on the surface. No noticeable shrinkage observed.
9. Blotted liquid from surface before weighing.
10. Blotted liquid from surface before weighing.
11. Sample fuming upon withdrawing from oven. Black liquid on bottom when blotted on paper towel ate holes in towel where absorbed.
12. Unreacted starting material for TGA.
13. None.
14. Observed shrinkage of isoprene.
15. Polyisoprene evidenced significant shrinkage and deformation. A piece of the isoprene strip broke off and a piece fell into oleum solution.
16. None.
17. Sample fuming upon withdrawal. Small drops of liquid on sample. Polyisoprene sample appears puffed.

Samples were analyzed in a combined DSC-TGA instrument (model TA SDT Q600) to look at both weight loss and exotherm/endotherm on heating to 600° C. under an inert atmosphere. Samples were heated at 10° C./minute under nitrogen starting at room temperature to a final temperature of 600° C. The first heating cycle was recorded. Weight loss at <300° C. and percent carbonized product obtained at 600° C. are shown in Table 3. It is believed that the weight loss in sample below 300° C. was due to loss of SO₂ and water from the samples. As shown in Table 3 the control polyethylene and polyisobutylene samples show essentially no weight loss (1.4 and 1.5%) respectively below 300° C. Samples exposed to SO₃ in the gas phase show progressively increasing weight loss below 300° C. with increasing exposure time to SO₃. These results are consistent with the increasing weight gain with increasing exposure to SO₃ as shown in Table 3.

Surprisingly, the present invention demonstrates a significant increased rate of reaction for polyolefins over what has been previously reported. D. Zhang, et al. Journal Applied Polymer Science, Vol. 62, 367-373 (1996) found that a polyethylene fiber treated with concentrated sulfuric acid at 150° C. for 30 minutes showed a 7% weight loss when heated to 300° C. in a TGA device. We have shown a similar extent of reaction, 6% weight loss, with a film sample after 1 minute of exposure to SO₃ vs. 30 minutes of exposure to concentrated sulfuric acid. Additionally, the reaction proceeded at a significantly and unexpectedly lower temperature, 80° C. vs. 150° C.

Example 2 further illustrates that the film samples produce a carbonized product as determined by TGA analysis when heated to 600° C.

### Example 3

Reaction of polyethylene with SO₃ in the liquid phase by using 20% oleum as the reaction medium.

The reactor as used in Examples 1 and 2 above was setup under a hood having a minimum air face velocity of 110 feet per minute. The reactor was purged with nitrogen for 45 minutes with 1 SCFH (>10 volume turnover). The wet trap was charged with 50% caustic and wet ice. The reactor was then charged with 349 grams of 20% oleum. The nitrogen gas flow rate was set at 0.05 SCFH and the reactor is heated to 80° C. with silicone oil in circulating jacket. This will give a sulfur trioxide concentration in the gas phase of approximately 5%.

Samples of linear low density polyethylene test strips were prepared as described above. The samples were placed onto sample hangers with inconel wire so that when placed in the reaction apparatus the samples were submerged in the 20% oleum liquid for 5 and 10 minute time intervals. Changes in weight and appearance are recorded in Table 4 below.

TABLE 4

| | | Exposure | | |
|---|---|---|---|---|
| Sample | Initial Wt. | Time | Final Wt. | % Wt. |
| No. | (grams) | (min.) | (grams) | Increase |
| 18 | 0.0373 | 5 | 0.0564 | 51 |
| 19 | 0.0556 | 10 | 0.087 | 56 |

Observations for each sample are as follows:
18. Turned black in 22 seconds. Shiny black with bubbly/textured surface.
19. Shiny black with bubbly/textured surface.

The results show that liquid 20% oleum at 80° C. is much more reactive with polyolefins than concentrated sulfuric acid as was earlier reported by D. Zhang, et al. Journal Applied Polymer Science, Vol. 62, 367-373 (1996). D. Zhang required 30 minutes at 150° C. to turn a polyethylene sample black vs. 22 seconds when subjected to a liquid containing SO₃ as we observed using 20% oleum.

Having described the invention in detail, those skilled in the art will appreciate that modifications may be made to the various aspects of the invention without departing from the scope and spirit of the invention disclosed and described herein. It is, therefore, not intended that the scope of the invention be limited to the specific embodiments illustrated and described but rather it is intended that the scope of the present invention be determined by the appended claims and their equivalents. Moreover, all patents, patent applications, publications, and literature references presented herein are incorporated by reference in their entirety for any disclosure pertinent to the practice of this invention.

What is claimed is:

1. A process for making an infusible polyolefin comprising the steps of:
a) contacting a polyolefin in a sulfonation reactor with a sulfonation mixture comprising sulfur trioxide to produce an infusible polyolefin;
b) recovering from the sulfonation reactor a recovery stream comprising sulfur dioxide;
c) oxidizing at least a portion of the sulfur dioxide in the recovery stream to produce an enriched recycle stream wherein the enriched recycle stream has an increased concentration of sulfur trioxide, relative to the recovery stream; and
d) combining at least a portion of the enriched recycle stream with the sulfonation mixture of step (a).

2. The process of claim 1 wherein the polyolefin is selected from the group consisting of polyethylene, polypropylene, polybutadiene; copolymers comprising polyethylene, copolymers comprising polypropylene, copolymers comprising polybutadiene; and mixtures thereof.

3. The process of claim 1 further comprising removing water from the recovery stream mixture of step (b) but prior to step (c).

4. The process of claim 3 wherein removing water comprises contacting the recovery stream mixture with a sulfuric acid solution.

5. The process of claim 1 wherein said sulfur trioxide is gaseous.

6. The process of claim 1 wherein the concentration of sulfur trioxide in said sulfonation mixture is from about 0.01 to 40 mole %, based on total moles of the sulfonation mixture.

7. The process of claim 1 wherein the concentration of sulfur trioxide in said sulfonation mixture is from about 0.1 to 30 mole % based on total moles of the sulfonation mixture.

8. The process of claim 1 wherein the concentration of sulfur trioxide in said sulfonation mixture is from about 1.0 to 20 mole % based on total moles of the sulfonation mixture.

9. The process of claim 1 wherein the concentration of sulfur trioxide in said sulfonation mixture is from about 0.5 to 10 mole % based on total moles of the sulfonation mixture.

10. The process of claim 1 wherein the concentration of sulfur trioxide in said sulfonation mixture is from about 1% to 5 mole % based on total moles of the sulfonation mixture.

11. The process of claim 1 or 2 wherein the concentration of sulfur trioxide in said sulfonation mixture is sufficient to react with said polyolefin to produce a temperature at the surface of the polyolefin substantially equal to the onset of the polyolefin melting temperature.

12. The process of claim 11 wherein the concentration of sulfur trioxide in said sulfonation mixture is sufficient to react with said polyolefin to produce a temperature that is less than about 5° C. to about 25° C. less the onset of the polyolefin melting temperature.

13. The process of claim 11 wherein the concentration of sulfur trioxide in said sulfonation mixture is sufficient to react with said polyolefin to produce a temperature that is more than 25° C. below the onset of the polyolefin melting temperature.

14. The process of claim 1 wherein said sulfonation mixture further comprises a gaseous diluent selected from the group consisting of carbon dioxide and sulfur dioxide.

15. The process of claim 1 wherein from about 1% to 100% of said sulfur trioxide in said sulfonation mixture is from said enriched recycle stream.

16. The process of claim 1 wherein from 1% to 50% of said sulfur trioxide in said sulfonation mixture is from said enriched recycle stream.

17. The process of claim 1 wherein from 1% to 10% of said sulfur trioxide in said sulfonation mixture is from said enriched recycle stream.

18. The process of claim 1 wherein from 1% to 5% of said sulfur trioxide in said sulfonation mixture is from said enriched recycle stream.

19. The process of claim 2 wherein said copolymer comprises of at least two monomers wherein one monomer is selected from the group consisting of ethylene and propylene, and a second monomer is selected from the group consisting of 2-butene, isoprene, butadiene, styrene, and combinations thereof.

20. The process of claim 19 wherein said polyolefin is a copolymer having at least one unsaturated carbon to carbon bond positioned from up to 50% away from a terminal carbon atom on the copolymer backbone.

21. The process of claim 19 wherein said polyolefin is a copolymer having at least one unsaturated carbon to carbon bond positioned at least 15% away from a terminal carbon atom up to 50% away from a terminal carbon atom on the copolymer backbone.

22. A process for making an infusible polyolefin comprising the steps of:
a) providing a polyolefin copolymer having at least one unsaturated carbon to carbon bond positioned up to about 50% away from a terminal carbon atom on the copolymer backbone.
b) contacting the polyolefin in a sulfonation reactor with a sulfonation mixture comprising sulfur trioxide to produce an infusible polyolefin;
c) recovering from the sulfonation reactor a recovery stream comprising sulfur dioxide and sulfur trioxide;
d) oxidizing at least a portion of the sulfur dioxide in the recovery stream to produce an enriched recycle stream wherein the enriched recycle stream has an increased concentration of sulfur trioxide, relative to the recovery stream; and
e) combining at least a portion of the enriched recycle stream with the sulfonation mixture of step (b).

23. The process of claim 22 wherein the polyolefin copolymer is selected from the group consisting of copolymers comprising polyethylene, copolymers comprising polypropylene, copolymers comprising polybutadiene; and mixtures thereof.

24. The process of claim 22 wherein said copolymer comprises of at least two monomers wherein one monomer is selected from the group consisting of ethylene and propylene and a second monomer is selected from the group consisting of 2-butene, isoprene, butadiene, styrene, and combinations thereof.

25. The process of claim 22 wherein said polyolefin is a copolymer having at least one unsaturated carbon to carbon bond positioned at least 15% up to 50% away from a terminal carbon atom on the copolymer backbone.

26. The process of claim 22 wherein said polyolefin has a degree of unsaturation in the polyolefin backbone of from about 1% to about 50% prior to sulfonation.

27. The process of claim 22 wherein said polyolefin has a degree of unsaturation in the polyolefin backbone of from about 1% to about 10% prior to sulfonation.

28. The process of claim 22 further comprising removing water from the recovery stream mixture of step (c) prior to step (d) to produce a recycle stream.

29. The process of claim 28 wherein removing water comprises contacting the recovery stream mixture with a solution comprising sulfuric acid.

30. The process of claim 22 wherein said sulfur trioxide is gaseous.

31. The process of claim 22 wherein the concentration of sulfur trioxide in said sulfonation mixture is from about 0.01 to 40 mole %, based on total moles of the sulfonation mixture.

32. The process of claim 22 wherein the concentration of sulfur trioxide in said sulfonation mixture is from about 1.0 to 20 mole % based on total moles of the sulfonation mixture.

33. The process of claim 22 wherein the concentration of sulfur trioxide in said sulfonation mixture is from about 0.5 to 10 mole % based on total moles of the sulfonation mixture.

34. The process of claim 22 wherein the concentration of sulfur trioxide in said sulfonation mixture is sufficient to react with said polyolefin to produce a temperature at the surface of the polyolefin substantially equal to the onset of the polyolefin melting temperature.

35. The process of claim 22 wherein the concentration of sulfur trioxide in said sulfonation mixture is sufficient to react with said polyolefin to produce a temperature at the surface of the polyolefin that is less than about 5° C. to about 25° C. below the onset of the polyolefin melting temperature.

36. The process of claim 22 wherein the concentration of sulfur trioxide in said sulfonation mixture is sufficient to react with said polyolefin to produce a temperature at the surface of the polyolefin that is less than about 10° C. below the onset of the polyolefin melting temperature.

37. The process of claim 22 wherein said sulfonation mixture further comprises a gaseous diluent selected from the group consisting of carbon dioxide and sulfur dioxide.

38. The process of claim 22 wherein from 1% up to 100% of said sulfur trioxide in said sulfonation mixture is from said enriched recycle stream.

39. The process of claim 22 wherein from 1% up to 50% of said sulfur trioxide in said sulfonation mixture is from said enriched recycle stream.

40. The process of claim 22 wherein from 1% up to 10% of said sulfur trioxide in said sulfonation mixture is from said enriched recycle stream.

41. The process of claim 22 wherein from 1% up to 5% of said sulfur trioxide in said sulfonation mixture is from said enriched recycle stream.

42. The process of claim 1 or 22 wherein the contacting of step is carried out at a temperature from about 20° C. to about 180° C.

43. The process of claim 42 wherein the contacting of step is carried out at a temperature from about 20° C. to about 120° C.

44. The process of claim 42 wherein the contacting of step is carried out at a temperature from about 40° C. to about 80° C.

45. The process of claim 1 or 22 wherein the oxidizing step comprises contacting the sulfur dioxide with an oxygen containing gas in the presence of an oxidation catalyst.

46. The process of claim 45 wherein the oxygen containing gas is substantially dry oxygen.

47. The process of claim 45 wherein the oxygen containing gas is substantially dry air.

48. The process of claim 1 or 22 further comprising scrubbing said enriched recycle stream to remove at least a portion of inert compounds.

49. The process of claim 48 wherein said inert compounds include carbon dioxide and nitrogen.

50. The process of claim 48 wherein said scrubbing step is performed before said combining step (d).

51. A process for making a carbon fiber comprising the steps of:
a) contacting a polyolefin in a sulfonation reactor with a sulfonation mixture comprising sulfur trioxide to produce an infusible polyolefin;
b) recovering from the sulfonation reactor a first recovery stream comprising sulfur dioxide and sulfur trioxide;
c) oxidizing at least a portion of the sulfur dioxide in the first recovery stream to produce an enriched recycle stream wherein the enriched recycle stream has an increased concentration of sulfur trioxide, relative to the first recovery stream;
d) combining at least a portion of the enriched recycle stream with the sulfonation mixture of step (a); and
e) carbonizing said infusible polyolefin to produce a carbon fiber.

52. The process of claim 51 wherein the polyolefin is selected from the group consisting of polyethylene, polypropylene, polybutadiene; copolymers comprising polyethylene, copolymers comprising polypropylene, copolymers comprising polybutadiene; and mixtures thereof.

53. The process of claim 52 wherein said copolymer comprises of at least two monomers wherein one monomer is selected from the group consisting of ethylene and propylene and a second monomer is selected from the group consisting of 2-butene, isoprene, butadiene, styrene, and combinations thereof.

54. The process of claim 53 wherein said polyolefin is a copolymer having at least one unsaturated carbon to carbon bond positioned from up to 50% away from a terminal carbon atom on the copolymer backbone.

55. The process of claim 53 wherein said polyolefin is a copolymer having at least one unsaturated carbon to carbon bond positioned at least 15% away from a terminal carbon atom up to 50% away from a terminal carbon atom on the copolymer backbone.

56. The process of claim 51 further comprising recovering from said carbonizing step a second recovery stream comprising sulfur dioxide.

57. The process of claim 56 wherein said first and second recovery streams are joined to form a combined recovery stream.

58. The process of claim 57 further comprising removing water from the combined recovery stream prior to step (c) to form a recycle stream.

59. The process of claim 51 wherein the concentration of sulfur trioxide in said sulfonation mixture is from about 0.01 mole % to 40 mole %, based on total moles of the sulfonation mixture.

60. The process of claim 51 wherein the concentration of sulfur trioxide in said sulfonation mixture is from about 1.0 mole % to 20 mole %, based on total moles of the sulfonation mixture.

61. The process of claim 51 wherein the concentration of sulfur trioxide in said sulfonation mixture is from about 0.5 mole % to less than 10 mole %, based on total moles of the sulfonation mixture.

62. The process of claim 51 wherein the concentration of sulfur trioxide in said sulfonation mixture is from about 1 mole % to 5 mole %, based on total moles of the sulfonation mixture.

63. The process of claim 51 wherein the concentration of sulfur trioxide in said sulfonation mixture is sufficient to react with said polyolefin to produce a temperature at the surface of the polyolefin substantially equal to the onset of the polyolefin melting temperature.

64. The process of claim 51 wherein the concentration of sulfur trioxide in said sulfonation mixture is sufficient to react with said polyolefin to produce a temperature at the surface of the polyolefin that is less than about 5° C. to about 25° C. below the onset of the polyolefin melting temperature.

65. The process of claim 51 wherein the concentration of sulfur trioxide in said sulfonation mixture is sufficient to react with said polyolefin to produce a temperature at the surface of the polyolefin that is less than about 10° C. below the onset of the polyolefin melting temperature.

66. The process of claim 51 wherein said sulfonation mixture further comprises a gaseous diluent selected from the group consisting of carbon dioxide and sulfur dioxide.

67. The process of claim 51 wherein from 1% to 100% of said sulfur trioxide in said sulfonation mixture is from said enriched recycle stream.

68. The process of claim 51 wherein from 1% to 50% of said sulfur trioxide in said sulfonation mixture is from said enriched recycle stream.

69. The process of claim 22 wherein from 1% to 5% of said sulfur trioxide in said sulfonation mixture is from said enriched recycle stream.

70. The process of claim 51 wherein the contacting of step is carried out at a temperature from about 20° C. to about 180° C.

71. The process of claim 51 wherein the contacting of step is carried out at a temperature from about 20° C. to about 120° C.

72. The process of claim 51 wherein the oxidizing step comprises contacting the sulfur dioxide with an oxygen containing gas in the presence of an oxidation catalyst.

73. The process of claim 51 wherein the oxygen containing gas is substantially dry oxygen.

74. The process of claim 51 wherein the oxygen containing gas is substantially dry air.

75. The process of claim 51 further comprising scrubbing said enriched recycle stream to remove at least a portion of inert compounds.

76. The process of claim 75 wherein said inert compounds include carbon dioxide and nitrogen.

77. The process of claim 75 wherein said scrubbing step is performed before said combining of the enriched recycle stream with the sulfonation mixture step.

78. The process of claim 51 wherein said heating step comprises an oven.

79. The process of claim 78 wherein said oven includes a plurality of heating zones.

80. The process of claim 79 wherein said plurality of heating zones includes a first heating zone having a temperature of from about 30° C. to about 300° C. and a second heating zone having a temperature of from about 300° C. to about 1800° C.

81. The process of claim 80 wherein said first heating zone has a temperature of from about 50° C. to about 300° C. and said second heating has a temperature of from about 300° C. to about 800° C.

82. The process of claim 53 wherein said polyolefin has a degree of unsaturation in the polyolefin backbone of from about 1% to about 50% prior to sulfonation.

83. The process of claim 1, 22 or 51 having a sulfur efficiency of from about 0.75 to about 1.5, based on the molar ratio of H₂SO₄ produced to sulfur consumed.

84. The process of claim 83 having a sulfur efficiency of from about 0.75 to about 1.25, based on the molar ratio of H₂SO₄ produced to sulfur consumed.

85. The process of claim 83 having a sulfur efficiency of about 1.0, based on the molar ratio of H₂SO₄ produced to sulfur consumed.

86. An apparatus for preparing an infusible polyolefin comprising a plurality of compartments in fluid communication wherein at least one compartment is adapted for contacting a polyolefin with gaseous sulfur trioxide.

87. The apparatus of claim 86 having at least one liquid seal.

88. The apparatus of claim 86 having a means for adjusting residence time for contacting sulfur trioxide.

89. The apparatus of claim 86 wherein said residence adjustment means includes a plurality of rollers or cams that can be adjusted in at least one plane of direction.
